(19) United States
(12) Patent Application Publication
(10) Pub. No.: US 2025/0389552 A1
(43) Pub. Date: Dec. 25, 2025

(54) SYSTEMS AND METHODS FOR DIFFERENTIALLY SENSING A MAGNETIC FIELD

(71) Applicant: Allegro MicroSystems, LLC, Manchester, NH (US)

(72) Inventors: Emil Pavlov, Heidelberg (DE); Till-Jonas Ostermann, Hirschberg (DE)

(73) Assignee: Allegro MicroSystems, LLC, Manchester, NH (US)

(21) Appl. No.: 18/748,234

(22) Filed: Jun. 20, 2024

(51) Int. Cl. G01D 5/245; G01P 3/487

(52) U.S. Cl. CPC G01D 5/245; G01P 3/487; G01D 2205/24

(57) ABSTRACT

Disclosed are example systems and methods for differentially sensing a magnetic field. In particular, described are example systems and methods that can be used to differentially sense magnetic fields generated by magnetic targets having a variety of characteristics. Using the systems and methods disclosed herein, a sensor device may be configured to differentially sense a magnetic field and provide stray field immunity in a variety of applications, where magnetic targets having a variety of different characteristics may be used.

### BACKGROUND

Sensor devices are often used to monitor parameters of a system. For example, sensor devices may be used to measure an angle of rotation of a rotation object, such as a rotor of an electric motor. The measured angle information may then be used to control the motor. For example, a controller may continuously receive a measured angle of rotation of the rotor, and may use this information to commutate the motor. That is, the measured angle information may be used by the controller to switch currents in motor windings, producing magnetic fields that cause the rotor to rotate. The controller can then control aspects of the motor, such as speed and torque, based on the measured angle information.

As another example, sensor devices may be used to measure speed and/or direction of rotation of a rotation object, such as a wheel. The speed and/or direction measurements may then be used in the implementation of driver assistance applications.

Numerous applications, spanning from industrial automation and robotics, to self-parking and power steering applications in automobiles, may require monitoring of a rotation angle, speed, or direction of a rotating shaft.

### SUMMARY

Disclosed are example systems and methods for differentially sensing a magnetic field. In particular, described are example systems and methods that can be used to differentially sense magnetic fields generated by magnetic targets having a variety of characteristics. Using the systems and methods disclosed herein, a sensor device may be configured to differentially sense a magnetic field and provide stray field immunity in a variety of applications, where magnetic targets having a variety of different characteristics may be used.

In accordance with some embodiments, there is provided a sensor device for sensing a magnetic field generated by a target. The sensor device comprises a first cluster of magnetic field sensing elements. The first cluster of magnetic field sensing elements comprises a first magnetic field sensing element and a second magnetic field sensing element positioned orthogonal to the first magnetic field sensing element. The system also comprises a second cluster of magnetic field sensing elements. The second cluster of magnetic field sensing elements is positioned a distance from the first cluster of magnetic field sensing elements and is configured to be positioned further from the target than the first cluster of magnetic field sensing elements. The second cluster of magnetic field sensing elements further comprises a third magnetic field sensing element and a fourth magnetic field sensing element positioned orthogonal to the third magnetic field sensing element.

In some embodiments, the first magnetic field sensing element and the third magnetic field sensing element each have a first axis of maximum sensitivity to a magnetic field, and the second magnetic field sensing element and the fourth magnetic field sensing element each have a second axis of maximum sensitivity to the magnetic field, wherein the first axis and the second axis are orthogonal to one another.

In further embodiments, at least one of the first magnetic field sensing element, the second magnetic field sensing element, the third magnetic field sensing element, and the fourth magnetic field sensing element is a vertical Hall plate element.

In still further embodiments, each of the first magnetic field sensing element, the second magnetic field sensing element, the third magnetic field sensing element, and the fourth magnetic field sensing element is a vertical Hall plate element.

In some embodiments, the first magnetic field sensing element and the third magnetic field sensing element are differentially coupled to produce a first channel signal.

In further embodiments, the second magnetic field sensing element and the fourth magnetic field sensing element are differentially coupled to produce a second channel signal.

In still further embodiments, the differential coupling of the first magnetic field sensing element and the third magnetic field sensing element and the differential coupling of the second magnetic field sensing element and the fourth magnetic field sensing element provides the sensor device with stray field immunity.

In some embodiments, a phase shift between the first channel signal and the second channel signal is ninety degrees.

In further embodiments, the sensor device further comprises a memory storing instructions and a controller. The controller, when executing the instructions, is configured to determine at least one of a speed at which the target is rotating, a direction in which the target is rotating, or an angle of rotation of the target.

In still further embodiments, the sensor device has a first side and a second side longer than the first side, wherein the sensor device is configured to sense the magnetic field of the target when the first side is facing the target.

In some embodiments, the sensor device has a first side configured to face the target and a second side configured to face away from the target, wherein the first cluster of magnetic field sensing elements is positioned proximal to the first side and the second cluster of magnetic field sensing elements is positioned proximal to the second side.

In further embodiments, the target comprises a ring magnet with magnetic pole pairs.

In still further embodiments, the target is radially magnetized.

In some embodiments, the target is axially magnetized.

In further embodiments, the target rotates around a rotation axis, and the sensor device is positioned so that the rotation axis passes through the sensor device.

In still further embodiments, the target rotates around a rotation axis, and the sensor device is positioned to the side of the rotation axis.

Furthermore, in accordance with some embodiments, there is provided a method for sensing a magnetic field generated by a target. The method comprises employing a first cluster of magnetic field sensing elements and a second cluster of magnetic field sensing elements in a sensor device, the second cluster being positioned a distance from the first cluster and configured to be positioned further from the target than the first cluster. The first cluster comprises a first magnetic field sensing element and a second magnetic field sensing element positioned orthogonal to the first magnetic field sensing element. The second cluster comprises a third magnetic field sensing element and a fourth magnetic field sensing element positioned orthogonal to the third magnetic field sensing element. The method further comprises determining at least one of a speed at which the target is rotating, a direction at which the target is rotating, or an angle of rotation of the target based on signals received from at least two of the first magnetic field sensing element, the second magnetic field sensing element, the third magnetic field sensing element, and the fourth magnetic field sensing element.

In some embodiments, the first magnetic field sensing element and the third magnetic field sensing element each have a first axis of maximum sensitivity to a magnetic field, and the second magnetic field sensing element and the fourth magnetic field sensing element each have a second axis of maximum sensitivity to the magnetic field, wherein the first axis and the second axis are orthogonal to one another.

In further embodiments, at least one of the first magnetic field sensing element, the second magnetic field sensing element, the third magnetic field sensing element, and the fourth magnetic field sensing element is a vertical Hall plate element.

In still further embodiments, the first magnetic field sensing element and the third magnetic field sensing element are differentially coupled to produce a first channel signal, and the second magnetic field sensing element and the fourth magnetic field sensing element are differentially coupled to produce a second channel signal.

In some embodiments, the differential coupling of the first magnetic field sensing element and the third magnetic field sensing element and the differential coupling of the second magnetic field sensing element and the fourth magnetic field sensing element provides the sensor device with stray field immunity.

In further embodiments, a phase shift between the first channel and the second channel is ninety degrees.

Additionally, in accordance with some embodiments, there is provided a system comprising a magnetic target and a sensor device. The sensor device comprises a first cluster of magnetic field sensing elements. The first cluster of magnetic field sensing elements comprises a first magnetic field sensing element and a second magnetic field sensing element positioned orthogonal to the first magnetic field sensing element. The sensor device also comprises a second cluster of magnetic field sensing elements positioned a distance from the first cluster of magnetic field sensing elements and configured to be positioned further from the target than the first cluster of magnetic field sensing elements. The second cluster of magnetic field sensing elements comprises a third magnetic field sensing element and a fourth magnetic field sensing element positioned orthogonal to the third magnetic field sensing element.

Before explaining example embodiments consistent with the present disclosure in detail, it is to be understood that the disclosure is not limited in its application to the details of constructions and to the arrangements set forth in the following description or illustrated in the drawings. The disclosure is capable of being practiced and carried out in various ways. Also, it is to be understood that the phraseology and terminology employed herein, as well as in the abstract, are for the purpose of description and should not be regarded as limiting.

It is to be understood that both the foregoing general description and the following detailed description are explanatory only and are not restrictive of the claimed subject matter.

### BRIEF DESCRIPTION OF THE DRAWINGS

The accompanying drawings are incorporated in and constitute part of this specification. The drawings, together with the description, illustrate and serve to explain the principles of various example embodiments of the disclosure.

FIG. 1A shows a diagram of an example system with an on-axis arrangement for detecting a magnetic field generated by a target.

FIG. 1B shows a diagram of an example system with an off-axis arrangement for detecting a magnetic field generated by a target.

FIG. 2A shows a diagram of an example sensor device for detecting rotation angles of a target.

FIG. 2B shows a diagram of an example system with an off-axis arrangement for detecting rotation angles of a target.

FIG. 3A shows a diagram of an example system with an off-axis arrangement for detecting speed and direction of rotation of a target.

FIG. 3B shows another diagram of an example system with an off-axis arrangement for detecting speed and direction of rotation of a target.

FIG. 4 shows a graph of pole pair sizes of example magnetic targets.

FIG. 5 shows a diagram of an example system with an off-axis arrangement for differentially sensing a magnetic field generated by a magnetic target, consistent with embodiments of the present disclosure.

FIG. 6 shows a graph of example simulated ratios of differentially measured magnetic field strengths as compared to simulated single-ended measured magnetic field strengths.

FIG. 7 shows a graph of an example simulation of phase shifts between a differentially measured magnetic field strength in a radial direction and a differentially measured magnetic field strength in a tangential direction.

FIG. 8 shows a graph of an example simulation of differentially measured magnetic field strengths in a radial direction.

FIG. 9 shows a graph of an example simulation of differentially measured magnetic field strengths in a tangential direction.

FIG. 10 shows a graph of an example simulation of values resulting from arctangent calculations of differentially measured magnetic field strengths in radial and tangential directions.

FIG. 11 shows a diagram of an example system for differentially sensing an axially magnetized magnetic target, consistent with embodiments of the present disclosure.

FIG. 12 shows a block diagram of an example sensor device, consistent with embodiments of the present disclosure.

FIG. 13 shows an example process for differentially sensing a magnetic field, consistent with embodiments of the present disclosure.

The drawings are not necessarily to scale, or inclusive of all elements of a system, emphasis instead generally being placed upon illustrating the concepts, structures, and techniques sought to be protected herein.

### DETAILED DESCRIPTION

Reference will now be made in detail to the embodiments of the disclosure, certain examples of which are illustrated in the accompanying drawings.

In the following description, numerous specific details are set forth regarding the systems and methods of the disclosed subject matter, and the environment in which such systems and methods operate, to provide a thorough understanding of the disclosed subject matter. After reading the descriptions provided herein, it will be apparent to one skilled in the art, however, that the disclosed subject matter may be practiced without such specific details. It will also be apparent to one skilled in the art that certain features, which are well known within the art, are not described in detail to avoid unnecessary complication of the description of the systems and methods described herein. In addition, it will be understood that the embodiments provided below are examples, and that it is contemplated that there are other systems and methods that are within the scope of the subject matter disclosed herein.

A magnetic field sensor device may be used to determine characteristics of a rotation object, such as a rotation angle of a rotation object, a rotation speed of a rotation object, and/or a rotation direction of a rotation object. With a magnetic field sensor device, one or more elements of the sensor device that are responsive to a magnetic field may be positioned near a rotation object and may either directly detect a magnetic field generated by the rotation object (e.g., if the rotation object is magnetized) or detect a magnetic field of a magnet attached to the rotation object. A magnetic field sensor device may be a good choice for fast, reliable, contactless measurement of the angular rotation position, rotation speed, and/or rotation direction of a system.

An object monitored by a sensor device is often referred to as a target. Accordingly, an object whose characteristics are sensed by the sensor device, such as a magnet or magnetized rotation object may be referred to as a “target” herein.

The term “magnetic field sensing element” may be used herein to describe any of a variety of electronic elements that may be used to sense a magnetic field. A magnetic field sensing element may be any type of element sensitive to a magnetic field. For example, a magnetic field sensing element may be a Hall-effect element (e.g., a Hall plate), a magnetoresistance element, or a magnetotransistor element. For example, a magnetic field sensing element may be a Hall-effect element such as a planar Hall element (e.g., plate), a vertical Hall element (e.g., plate), or a circular vertical Hall (CVH) element (e.g., plate). A magnetic field sensing element may instead by a magnetoresistance element, such as an Indium Antimonide (InSb) element, a giant magnetoresistance (GMR) element (e.g., a spin valve element), an anisotropic magnetoresistance (AMR) element, a tunneling magnetoresistance (TMR) element, or a magnetic tunnel junction (MTJ) element. A magnetic field sensing element may be a receiving coil field sensing element. A magnetic field sensing element may be a single element, or alternatively may include two or more magnetic field sensing elements arranged in one of various configurations, such as a half bridge or a full (Wheatstone) bridge. Depending on the type of sensor device and application requirements, a magnetic field sensing element may be a device made of a type IV semiconductor material such as Silicon (Si) or Germanium (Ge), or of a type III-V semiconductor material such as Gallium-Arsenide (GaAs), or an Indium compound such as Indium-Antimonide (InSb).

Some of the above-described magnetic field sensing elements tend to have an axis of maximum sensitivity that is parallel to a substrate that supports the magnetic field sensing element, while others of the above-described magnetic field sensing elements tend to have an axis of maximum sensitivity that is perpendicular to a substrate that supports the magnetic field sensing element. For example, a planar Hall plate element may have an axis of maximum sensitivity that is perpendicular to a substrate, while a metal-based or metallic magnetoresistance element (e.g., GMR, TMR, AMR) or vertical Hall plate element may have an axis of maximum sensitivity that is parallel to a substrate.

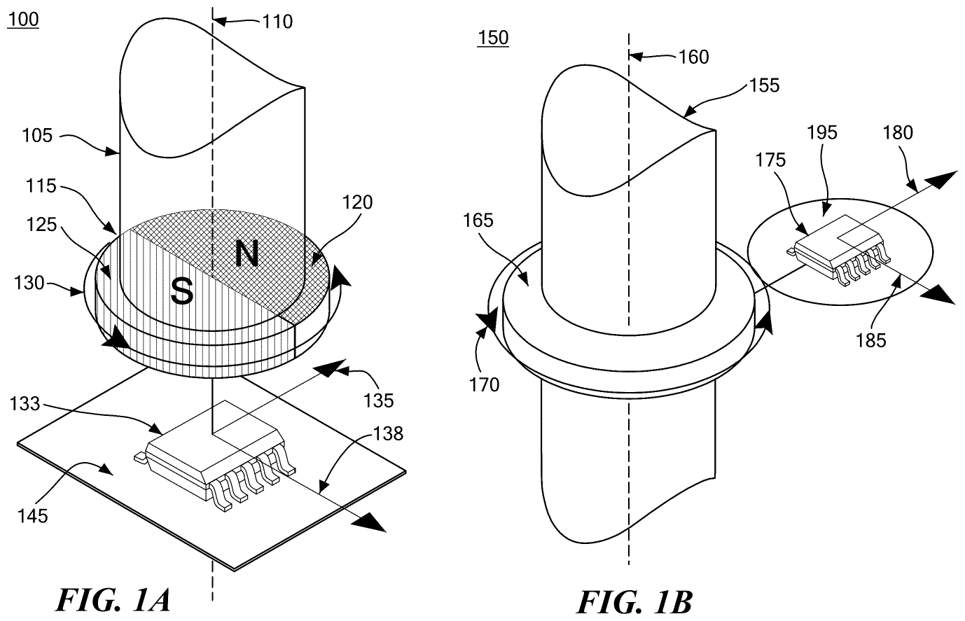

FIGS. 1A and 1B show example systems 100 and 150, respectively, that may be used to measure a rotation angle of a rotation object using a magnetic field sensor device. In systems 100 and 150, the rotation objects comprise shafts (e.g., shaft 105 of system 100, shaft 155 of system 150), such as rotors, and are illustrated as rotating around an axis (e.g., axis 110 of system 100, axis 160 of system 150). The rotation object can rotate around an axis clockwise or counterclockwise, or can rotate clockwise at some times and counterclockwise at other times. In FIGS. 1A and 1B, arrows 130 and 170 of systems 100 and 150, respectively, illustrate a counterclockwise rotation of a rotation object about an axis, when viewed along the axis of rotation (e.g., axis 110 of FIG. 1A, axis 160 of FIG. 1B) from above. Although FIGS. 1A and 1B illustrate example systems where a shaft or rotor rotates, the disclosure is not so limited. A person of ordinary skill in the art would recognize that magnetic field sensor devices may be used to detect a rotation angle of any object that rotates, not just shafts or rotors, so long as that object is magnetized or has a magnet attached to it.

In some embodiments, a rotation object (e.g., rotation object 105, rotation object 155) may be magnetized, such that a magnetic field sensor device may sense a magnetic field generated by the rotation object. Alternatively, a magnet may be attached to a rotation object and the magnet may generate a magnetic field, allowing for detection of the magnetic field by a magnetic field sensor device. The magnet may be attached such that the magnet rotates with the rotation object. For example, FIG. 1A illustrates an example system 100 where a disc magnet 115 is attached to an end (e.g., bottom) of rotation object 105. FIG. 1B illustrates an example system 150 where a ring magnet 165 is attached at a point along rotation object 155, with rotation object 155 passing through ring magnet 165. The disclosure is not limited to the examples shown in FIGS. 1A and 1B. A magnet may be attached at any point in relation to a rotation object, so long as the magnet rotates with the rotation object. As one example, although not shown, a magnet may be attached to another end (e.g., top) of rotation object 105.

In example system 100 of FIG. 1A, magnet 115 is shown as being a diametrically magnetized disc magnet with a north pole 120 and a south pole 125. In example system 150 of FIG. 1B, magnet 165 is shown as being a ring magnet. However, the disclosure is not limited to these examples. A person of ordinary skill in the art would recognize that other form factors of magnets may be used, including, for example, disc magnets, ring magnets, cylinder magnets, or other form factors of a magnet.

A person of ordinary skill in the art would also recognize that a magnet (e.g., magnet 115 of FIG. 1A, magnet 165 of FIG. 1B) may be a permanent magnet that stays magnetized once magnetized, a temporary magnet that behaves like a magnet only when near a magnetic field, an electromagnet that behaves like a magnet only when electricity is applied, or any other type of magnet. A person of ordinary skill in the art would recognize that a magnet (e.g., magnet 115 of FIG. 1A, magnet 165 of FIG. 1B) may be made of any type of magnetic material, such as neodymium (e.g., neodymium-iron-boron (NdFEB)), samarium cobalt (e.g., SmCo), alnico (e.g., aluminum, nickel, cobalt), ceramic or ferrite (e.g., strontium carbonate, iron oxide), or any other type of magnetic material. Although magnet 115 in FIG. 1A is illustrated as being diametrically magnetized, the disclosure is not so limited. A magnet (e.g., magnet 115 of FIG. 1A, magnet 165 of FIG. 1B) used in a system (e.g., system 100 of FIG. 1A, system 150 of FIG. 1B) may, for example, instead be axially magnetized. And although magnet 115 in FIG. 1A shows one north pole 120 and one south pole 125, the disclosure is not so limited. A person of ordinary skill in the art would recognize that a magnet (e.g., magnet 115 of FIG. 1A, magnet 165 of FIG. 1B) may have any number of north and south poles.

One or more magnetic field sensing elements for sensing a magnetic field of a magnet may be positioned near the magnet. In example system 100 of FIG. 1A, for example, a package 133 (e.g., integrated circuit) including one or more magnetic field sensing elements is positioned near magnet 115. System 100 of FIG. 1A is an example of an on-axis arrangement, in that the one or more magnetic field sensing elements in package 133 are aligned along the rotation axis (e.g., axis 110) of the target (e.g., magnet 115). Package 133 may be positioned near magnet 115 by package 133 being positioned on a surface 145, such as a printed circuit board (PCB) or other surface, near magnet 115.

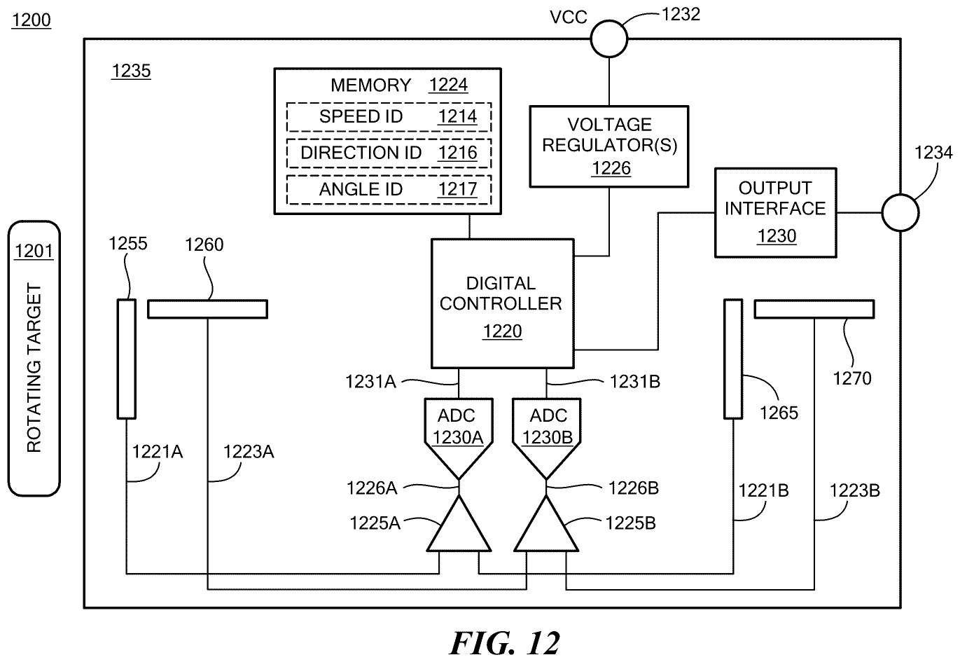

In example system 150 of FIG. 1B, a package 175 (e.g., integrated circuit) is positioned near magnet 165. Package 175 may include one or more magnetic field sensing elements for sensing the magnetic field of magnet 165. System 150 of FIG. 1B is an example of an off-axis arrangement, in that the one or more magnetic field sensing elements in package 175 are not aligned with the rotation axis (e.g., axis 160) of the target (e.g., magnet 165). Package 175 may be positioned near magnet 165 by mounting package 175 on a surface 195, such as a PCB or other surface, near magnet 165. In addition to including one or more magnetic field sensing elements, a package (e.g., package 133 of FIG. 1A, package 175 of FIG. 1B) may also include additional circuitry (see, e.g., FIG. 12) for conditioning and/or processing signals representing the magnetic field generated by the one or more magnetic field sensing elements. Although FIGS. 1A and 1B illustrate the one or more magnetic field sensing elements and additional circuitry as being included in a package, the disclosure is not so limited. A person of ordinary skill in the art would recognize, for example, that the one or more magnetic field sensing elements and any additional circuitry may be mounted as separate components on a PCB or other substrate, for example. Alternatively, some components may be included in a package, while other components may be external to the package.

In some embodiments, the one or more magnetic field sensing elements may include at least two magnetic field sensing elements, positioned orthogonally to each other, each having an axis of maximum sensitivity to a magnetic field. For example, if system 100 of FIG. 1A were mapped to X, Y, and Z axes in a Cartesian coordinate system, axis 135 may be thought of as an X axis, axis 138 may be thought of as a Y axis, and axis 110 may be thought of as a Z axis. In some embodiments, two magnetic field sensing elements may be used to measure an angle of rotation of a target, with one of the magnetic field sensing elements sensitive to the magnetic field along one of the X and Y axes, and the other magnetic field sensing element sensitive to the magnetic field along the other of the X and Y axes. For example, FIG. 1A illustrates that one magnetic field sensing element in package 133 may be sensitive to a magnetic field along one axis 135 (e.g., X axis) and that another magnetic field sensing element in package 133 may be sensitive to the magnetic field along an axis 138 (e.g., Y axis) that is orthogonal to axis 135. Similarly, FIG. 1B illustrates that one magnetic field sensing element in package 175 may be sensitive to a magnetic field along one axis 180 (e.g., X axis) and that another magnetic field sensing element in package 175 may be sensitive to the magnetic field along an axis 185 (e.g., Y axis) that is orthogonal to axis 180. The output of the magnetic field sensing elements may be processed and/or conditioned and sent to one or more controllers of the integrated circuit. The processed signals received by the controller(s) may be referred to as channels, with one channel corresponding to the processed and/or conditioned signal output from one of the magnetic field sensing elements, and the other channel corresponding to the processed and/or conditioned signal output from another of the magnetic field sensing elements.

In response to the magnetic field generated by the target (e.g., magnet 115, magnet 165), the magnetic field sensing elements may each provide a voltage output that is proportional to the magnitude of the sensed magnetic field. The voltage output may vary as the target rotates due to changes in the magnetic field generated by the target and detected by the magnetic field sensing elements. When the magnetic field is sensed over a rotation of 360 degrees, the voltage output from one of the magnetic field sensing elements may appear as a sine curve over the 360 degrees of rotation and the voltage output from the other of the magnetic field sensing elements may appear as a cosine curve over the 360 degrees of rotation. In the example shown in FIG. 1A, there is only one pole pair for an entire 360 degree rotation of the rotation object, so a period of the sine curve and cosine curve may correspond to a complete 360 degree rotation of the rotation object. However, as discussed above, the disclosure is not so limited and a target may have multiple pole pairs, in which case each one of the multiple pole pairs that passes a sensor device in response to rotation of the rotation object may correspond to a measured 360 degrees of rotation of the target, and a period of the sine curve and a period of the cosine curve may correspond to a rotation that causes one of the multiple pole pairs to pass the sensor device.

An inverse tangent function (i.e., arctan function) may be applied to the voltages measured from the magnetic field sensing elements at any given time to calculate an angle of rotation of the target at that time. For example, the two-argument arctangent function a tan 2, commonly used in computing and mathematics, may be used to calculate a rotation angle of the target based on the voltage output signals from the two orthogonal magnetic field sensing elements at a given time. Various other techniques may be used to determine a measured rotation angle of the target instead of using an inverse tangent function, such as by using a lookup table, a polynomial fit, or a coordinate rotation digital computer (CORDIC) calculation. The calculations and/or processing required to determine the measured angle may be carried out by one or more controllers in the sensor device. That is, one or more controllers inside the package may receive signals from the two channels and determine a measured angle of rotation of the target based on the two channel signals using an inverse tangent function, lookup table, polynomial fit, or CORDIC calculation.

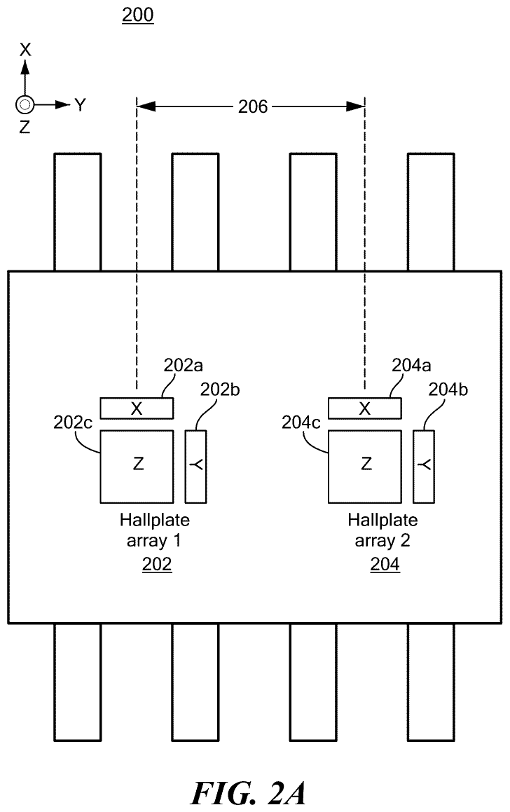

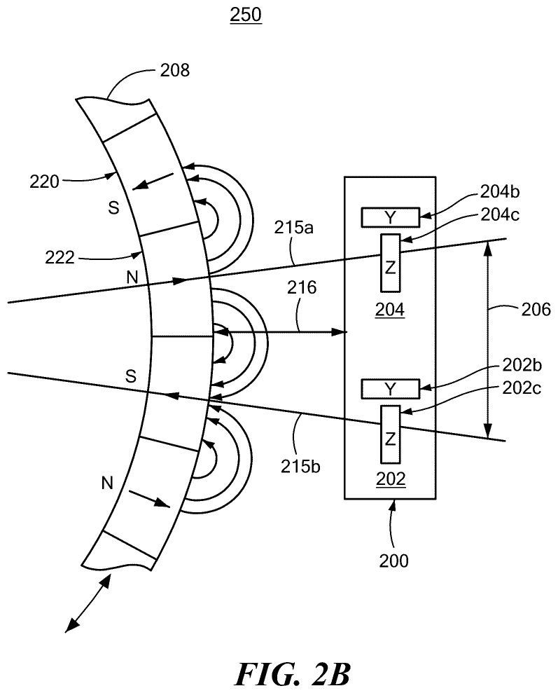

FIG. 2A shows a diagram of an example sensor device 200 for detecting rotation angles of a target. In operation, sensor device 200 would be flipped 90 degrees in either direction over the Y-axis, such that the top of the sensor device integrated circuit (IC) shown in FIG. 2A is facing toward a target or away from a target, and such that each of the Hall plates is positioned at approximately the same distance from the target (see, e.g., FIG. 2B). Sensor device 200 may include a first array (e.g., Hallplate array 1) of magnetic field sensing elements 202 (e.g., Hall plates) and a second array (e.g., Hallplate array 2) of magnetic field sensing elements 204 (e.g., Hall plates). First array 202 and second array 204 may be separated from each other by a selected distance 206.

First array 202 may comprise three magnetic field sensing elements (e.g., Hall plates), each having an axis of maximum sensitivity that is orthogonal to the others. For example, first array 202 may include a magnetic field sensing element 202a (e.g., Hall plate) with an axis of maximum sensitivity along an X-axis, a magnetic field sensing element 202b (e.g., Hall plate) with an axis of maximum sensitivity along a Y-axis, and a magnetic field sensing element 202c (e.g., Hall plate) with an axis of maximum sensitivity along a Z-axis.

Similarly, second array 204 may comprise three magnetic field sensing elements (e.g., Hall plates), each having an axis of maximum sensitivity that is orthogonal to the others. For example, second array 204 may include a magnetic field sensing element 204a (e.g., Hall plate) with an axis of maximum sensitivity along an X-axis, a magnetic field sensing element 204b (e.g., Hall plate) with an axis of maximum sensitivity along a Y-axis, and a magnetic field sensing element 204c (e.g., Hall plate) with an axis of maximum sensitivity along a Z-axis.

Sensor device 200 may include the two arrays of magnetic field sensing elements, with elements in one of the arrays having axes of maximum sensitivity that are roughly parallel to axes of maximum sensitivity of respective elements in the other array, in order to provide stray field immunity. For example, magnetic field sensing element 202a may be differentially coupled with magnetic field sensing element 204a to provide stray field immunity. That is, a difference between the signal output from magnetic field sensing element 202a and the signal output from magnetic field sensing element 204a may be detected at any given time. The signal resulting from this difference may be representative of the magnetic field generated by the target at that time, given the spacing between the magnetic field sensing elements and how they sense the magnetic field generated by the target differently given this spacing. For example, the two magnetic field sensing elements may output signals that are phase-shifted from one another, given the spacing of the magnetic field sensing elements and their spatial relationship with the target, and as a result taking a difference between the two signals may not cancel the signals out. However, taking the difference between the signals output from the magnetic field sensing elements should eliminate (or greatly diminish) any contributions to the output signal from the magnetic field in the environment that is not directly attributable to the target and that was sensed by the magnetic field sensing elements. That is, assuming a typical environment where the magnetic field may be relatively constant (outside of the field generated by the target), taking the difference between the signal output from magnetic field sensing element 204a and the signal output from magnetic field sensing element 202a (or vice versa) should largely remove contributions of any magnetic field present in the environment and unrelated to the target to the output signal, while still providing an output signal that is representative of the magnetic field generated by the target. Magnetic field sensing element 202b and magnetic field sensing element 204b may be similarly differentially coupled. Magnetic field sensing element 202c and magnetic field sensing element 204c may also be similarly differentially coupled.

Magnetic field sensing elements in the arrays that are differentially coupled together may be positioned a distance 206 from each other. For example, magnetic field sensing element 202a may be positioned approximately a distance 206 from magnetic field sensing element 204a, magnetic field sensing element 202b may be positioned approximately distance 206 from magnetic field sensing element 204b, and magnetic field sensing element 202c may be positioned approximately distance 206 from magnetic field sensing element 204c. Distance 206 may be selected based on the distance across a pole pair of the target. That is, an optimal peak-to-peak amplitude of the output signal from the differentially coupled magnetic field sensing elements may occur when distance 206 is a particular value, and that particular value may depend on the distance across a pole pair of the target.

FIG. 2B shows a diagram of an example system 250 with an off-axis arrangement for detecting rotation angles of a target 208. Target 208 may be a ring magnet, for example, with one or more south poles 220 and one or more north poles 222. Sensor device 200 may be the same sensor device as discussed with respect to FIG. 2A, but shown here on its side as it would be in operation. Sensor device 200 may be spaced an air gap distance 216 from target 208. A first tangent 215a extends from a surface of target 208 at a middle of a north pole 222, and a second tangent 215b extends from a surface of target 208 at a middle of a south pole 220. As shown in FIG. 2B, a pitch of the north and south magnetic poles approximately matches the spacing of the first and second magnetic field sensing arrays 202, 204 for a given air gap distance 216. Matching a spacing between the magnetic field sensing arrays to a spacing between the poles of the ring magnet may provide for detection of a maximum differential signal amplitude, while providing stray field immunity due to the differential nature of the sensor.

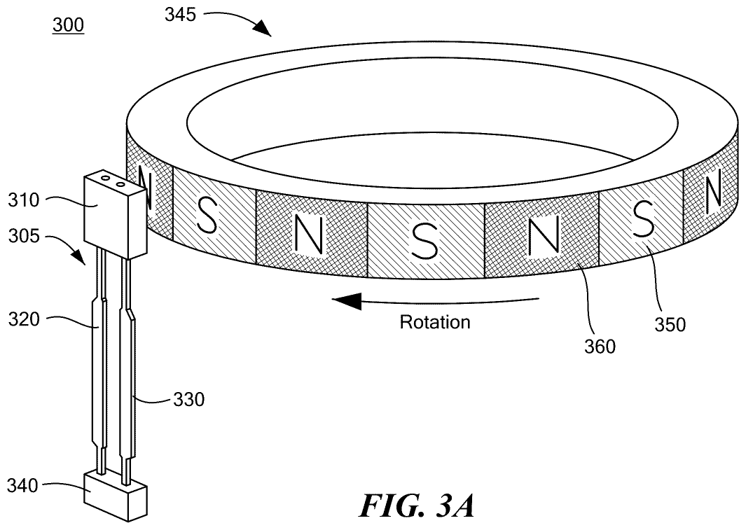

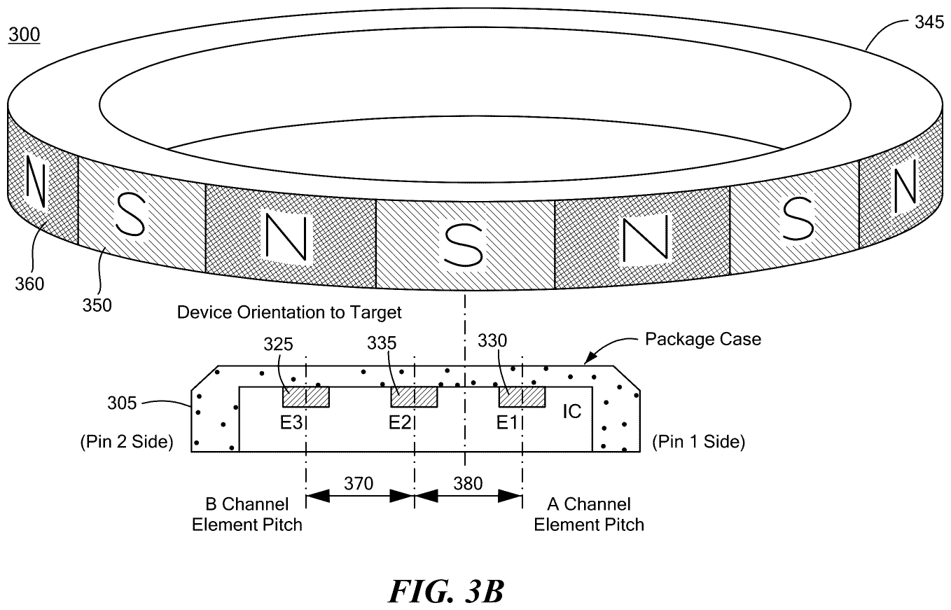

FIG. 3A shows a diagram of an example rotation speed and/or rotation direction sensor system 300, including a sensor device 305 and a magnetic target 345. Components of sensor device 305 may, for example, be placed in a system-in-package (SIP) package 310, as shown in FIG. 3A. One of pins 320 and 330 may be a Vcc terminal and another of pins 320 and 330 may be a ground (GND) terminal. 340 may be a structural component (e.g., plastic) configured to hold pins 320 and 330 in position. Sensor device 305 may measure the magnetic field strength of target 345 as it rotates. FIG. 3A shows an example where target 345 is a ring magnet with alternating magnetic poles (e.g., one or more north poles 360, one or more south poles 350). Ring magnet 345 may be attached to a larger rotating object, such as a wheel of a vehicle. Monitoring the rotation of ring magnet 345 by sensing magnetic fields generated by target 345 as it rotates may allow sensor device 305 to determine a rotation speed and/or rotation direction of target 345.

FIG. 3B shows another diagram of example speed and/or direction sensor system 300 shown in FIG. 3A. In the example shown in FIG. 3B, sensor device 305 includes three magnetic field sensing elements (e.g., magnetic field sensing element 325, magnetic field sensing element 335, magnetic field sensing element 330). For example, magnetic field sensing element 330 may be differentially paired with magnetic field sensing element 335 to generate one channel signal (e.g., Channel A), and magnetic field sensing element 325 may be differentially paired with magnetic field sensing element 335 to generate another channel signal (e.g., Channel B). The differential pairing of the signals may provide for immunity to magnetic stray fields from the environment (and not directly attributable to the target).

Magnetic field sensing element 330 may be positioned a distance 380 from magnetic field sensing element 335, and magnetic field sensing element 325 may be positioned a distance 370 from magnetic field sensing element 335. Distance 370 and distance 380 may be approximately the same, and may be selected depending on the distance across a pole pair of target 345. For example, sensor device 305 may be optimally configured when distance 370 and distance 380 are both approximately one quarter of the distance across a magnetic pole pair of target 345. For example, distance 370 and distance 380 may each be approximately 1.5 millimeters (mm) when the distance across a magnetic pole pair of target 345 is approximately 6 mm.

Speed of rotation of a target (e.g., target 345) may be detected, for example, by determining how often a signal output from a differential channel (e.g., Channel A) crosses a particular preset threshold value. For example, a particular voltage value may be preset, and a controller or other circuitry may record the number of times a voltage of the signal from the differential channel exceeds the preset voltage value in a certain amount of time. Speed of rotation of the target may then be calculated, such as by a controller or by a computing device that receives signals from the sensor device over a communications medium. In some embodiments, a threshold value may be set to correspond to a steep part of the sine/cosine curve to more accurately determine when the differential signal crosses the threshold value. The threshold value may be set to, for example, one or more of 25%, 30%, 40%, 60%, 70%, and/or 75% of the peak-to-peak amplitude of the sine/cosine curve, where the slope of the sine/cosine curve is steeper than at its peak, though the disclosure is not limited to these specific examples.

Providing two differential channels (i.e., Channel A and Channel B) of sensor device 305 may allow for direction of rotation to be determined. For example, as previously discussed, each of the differentially paired magnetic field sensing elements may output a channel signal (e.g., Channel A, Channel B) that roughly corresponds to a sine or cosine curve as the target rotates. One of skill in the art will recognize that a sine curve and a cosine curve are the same curve, but with a 90 degree phase shift between them. Therefore, such a curve may be referred to as a sine/cosine curve herein. By determining which of the signals from Channel A or Channel B leads or lags the other (e.g., by looking at relative phase or time difference), sensor device 305 may determine the direction of rotation of target 345.

As discussed above, a sensor device may output signals that may be used to determine rotation angle, speed, and/or direction of a target while providing stray field immunity. However, as also discussed above, a spacing between the differentially coupled magnetic field sensing elements in a sensor device may need to be roughly matched to one or more characteristics of a target (e.g., pole pair size of a ring magnet) in a particular application, in order to optimize the amplitudes of the differential signals that are output. This may pose a technical obstacle, as a variety of different targets may be used in different applications, and the pole pair sizes of these different targets may vary significantly. As a result, a number of different sensor devices with different spacings between the magnetic field sensing elements may need to be manufactured to accommodate the wide variety of targets. Such an approach may be inefficient and costly.

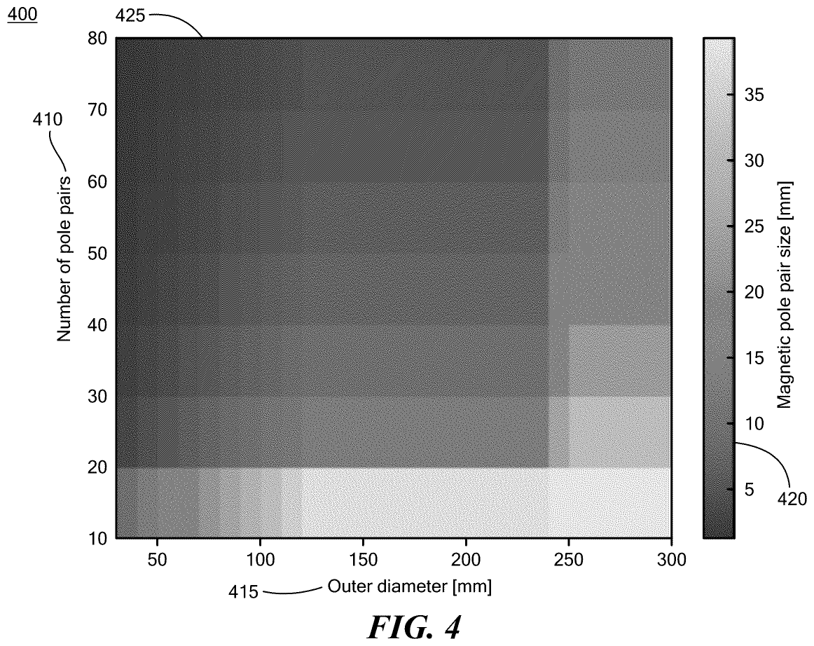

FIG. 4 shows a graph 400 of pole pair sizes of example ring magnet targets. Graph 400 includes a Y-axis 410 that corresponds to numbers of pole pairs in a ring magnet target, and includes an X-axis 415 that corresponds to outer diameters of a ring magnet target in millimeters (mm). 420 is a legend showing the shading that corresponds to a particular pole pair size (in mm), and 425 is a plot showing how the magnetic pole pair size varies for targets having different numbers of pole pairs and outer diameters. As can be seen in FIG. 4, pole pair size may vary greatly depending on the number of pole pairs and outer diameter of a magnetic target. Targets may have numbers of pole pairs, outer diameters, and/or pole pair sizes that are different than those shown in FIG. 4. FIG. 4 merely provides example dimensions of example targets.

Embodiments of the present disclosure provide systems and methods for differentially sensing a magnetic field. In particular, described are example systems and methods that can be used to differentially sense magnetic fields generated by magnetic targets having a variety of characteristics (e.g., numbers of pole pairs, outer diameters, pole pair sizes). Using the systems and methods disclosed herein, a sensor device may be configured to differentially sense a magnetic field and provide stray field immunity in a variety of applications, where magnetic targets having a variety of different characteristics may be used.

Example systems and methods disclosed herein provide for a sensor device that can differentially sense a magnetic field to determine a rotation angle, rotation speed, and/or rotation direction of a target. Example systems and methods disclosed herein may also provide for a sensor device that can be used in on-axis or off-axis arrangements, and that can be used with radially magnetized or axially magnetized targets. Example systems and methods disclosed herein provide for a sensor device that may have two clusters of magnetic field sensing elements, one cluster being positioned closer to a target than the other cluster. Magnetic field sensing elements from each cluster may be differentially coupled. This differential coupling may provide for immunity to magnetic stray fields in the environment (that may not be directly attributable to the target). The sensor device may be configured in such a way as to provide for accurate sensing of a magnetic field that may be used to determine rotation angle, rotation speed, and/or rotation direction, regardless of a pole pair size of the target. That is, systems and methods disclosed herein provide for a sensor device that can be used with targets having a variety of characteristics, in a variety of different applications, such that the same sensor device may be used to sense magnetic fields generated by targets having a wide range of different characteristics.

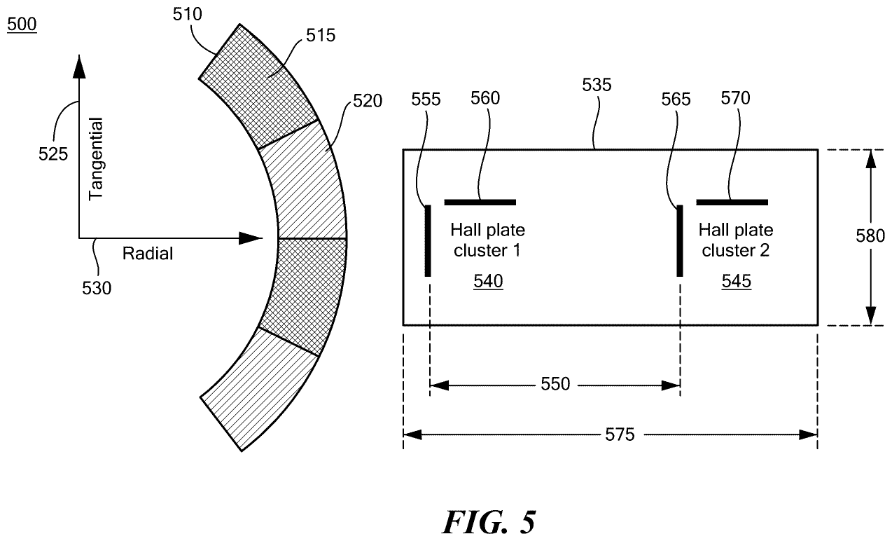

FIG. 5 shows a diagram of an example system 500 with an off-axis arrangement for differentially sensing a magnetic field generated by a target 510, consistent with embodiments of the present disclosure. Example target 510 in FIG. 5 may be a ring magnet that is radially magnetized with one or more south poles 515 and one or more north poles 520, though the disclosure is not so limited. For example, as discussed above, the target can be any of many different forms of targets. A sensor device 535 may be positioned next to target 510 and may sense a magnetic field generated by target 510 as target 510 rotates. For example, a sensor device may include two clusters of magnetic field sensing elements for sensing the magnetic field generated by a target. FIG. 5 shows example sensor device 535 as including a first cluster 540 (e.g., Hall plate cluster 1) that comprises two vertical Hall plates 555, 560 positioned orthogonal (i.e., perpendicular) to each other. FIG. 5 also shows example sensor device 535 as including a second cluster 545 (e.g., Hall plate cluster 2) that comprises two vertical Hall plates 565, 570 positioned orthogonal to each other. However, the disclosure is not so limited. For example, one of ordinary skill in the art would recognize that other types of magnetic field sensing elements may be used instead of vertical Hall plates, and that combinations of two or more different types of magnetic field sensing elements may be used together to sense the magnetic field generated by target 510.

In some embodiments, a magnetic field sensing element (e.g., vertical Hall plate 555, vertical Hall plate 565) from each cluster may have an axis of maximum sensitivity to the magnetic field generated by the target in a radial direction 530, and another magnetic field sensing element (e.g., vertical Hall plate 560, vertical Hall plate 570) from each cluster may have an axis of maximum sensitivity to the magnetic field generated by the target in a tangential direction 525.

The magnetic field sensing elements may also be differentially coupled. For example, the magnetic field sensing elements that have an axis of maximum sensitivity in a radial direction 530 (e.g., vertical Hall plate 555, vertical Hall plate 565) may be differentially coupled together, and the magnetic field sensing elements that have an axis of maximum sensitivity in a tangential direction 525 (e.g., vertical Hall plate 560, vertical Hall plate 570) may be differentially coupled together. In some embodiments, a difference between a signal output from a magnetic field sensing element (e.g., vertical Hall plate 555) in a first cluster 540 (e.g., Hall plate cluster 1) and a signal output from its differentially coupled magnetic field sensing element (e.g., vertical Hall plate 565) in a second cluster 545 (e.g., Hall plate cluster 2) may be determined and output as one channel signal (e.g., Channel A). A difference between a signal output from a magnetic field sensing element (e.g., vertical Hall plate 560) in first cluster 540 (e.g., Hall plate cluster 1) and a signal output from its differentially coupled magnetic field sensing element (e.g., vertical Hall plate 570) in second cluster 545 (e.g., Hall plate cluster 2) may also be determined and output as another channel signal (e.g., Channel B). The differences between the signals output from the magnetic field sensing elements may be determined, for example, as shown in Equations 1 and 2 below.

Channel A=output of magnetic field sensing element (e.g., element 555) in cluster 1 (e.g., cluster 540)−output of magnetic field sensing element (e.g., element 565) in cluster 2 (e.g., cluster 545) Equation 1:

Channel B=output of magnetic field sensing element (e.g., element 560) in cluster 1 (e.g., cluster 540)−output of magnetic field sensing element (e.g., element 570) in cluster 2 (e.g., cluster 545) Equation 2:

where the outputs of the magnetic field sensing elements may be voltage and/or current values.

In some embodiments, differences between the outputs of the differentially coupled magnetic field sensing elements may be determined continuously. For example, outputs of the two differentially coupled magnetic field sensing elements may be continuously coupled into a differential amplifier, and a difference between the two outputs continuously output from the differential amplifier. Alternatively, outputs of the magnetic field sensing elements may be sampled at periodic intervals and differences between the outputs determined at those intervals.

As shown in FIG. 5, clusters of magnetic field sensing elements may be positioned in a sensor device, such as in example sensor device 535, such that, in operation in a system (e.g., system 500), one cluster (e.g., cluster 540) of magnetic field sensing elements is closer to the target than the other cluster (e.g., cluster 545) of magnetic field sensing elements. In some embodiments, a sensor device (e.g., sensor device 535) comprises differentially coupled magnetic field sensing elements that are positioned a distance from each other. For example, a sensor device may be configured such that a magnetic field sensing element (e.g., vertical Hall plate 555) in one cluster 540 (e.g., Hall plate cluster 1) may be positioned a distance 550 from its differentially coupled magnetic field sensing element (e.g., vertical Hall plate 565) in another cluster 545 (e.g., Hall plate cluster 2). The sensor device may also be configured such that another magnetic field sensing element (e.g., vertical Hall plate 560) in cluster 540 may also be positioned a distance from its differentially coupled magnetic field sensing element (e.g., vertical Hall plate 570), and in some embodiments this distance may be the same as distance 550, though the disclosure is not so limited. In providing magnetic field sensing elements positioned a distance 550 from each other, the magnetic field of the target may be sensed at two different locations along a magnetization axis (e.g., the magnetization axis in radial direction 530).

In some embodiments, a sensor device may be configured such that a cluster of magnetic field sensing elements is positioned near each end of the sensor device. For example, as shown in the example in FIG. 5, sensor device 535 includes a cluster 540 positioned near (i.e., proximal to) a first side of the sensor device that is near target 510, and also includes a cluster 545 positioned near (i.e., proximal to) a second side of the sensor device that is further away from target 510. In some embodiments, a sensor device may have a substantially rectangular profile when viewed from above with four sides, two of the sides being shorter (e.g., a distance 580) in length and two of the sides being longer (e.g., a distance 575) in length, as shown in the example in FIG. 5. In operation, the sensor device (e.g., sensor device 535) may be positioned such that one of the shorter sides faces toward the target and one of the shorter sides faces away from the target.

One of skill in the art would recognize that a strength of a magnetic field generated by a target may drop exponentially with distance from the target. As a result, in the example shown in FIG. 5, magnetic field sensing element 555 in cluster 540 may detect a greater magnetic field strength than its differentially coupled magnetic field sensing element 565 in cluster 545. Likewise, magnetic field sensing element 560 in cluster 540 may detect a greater magnetic field strength than its differentially coupled magnetic field sensing element 570 in cluster 545. As a result, the signals output from the differentially coupled magnetic field sensing elements will not cancel each other out when a difference is taken between the outputs to obtain a differential signal. The distance between the differentially coupled magnetic field sensing elements may depend on the die size of the sensor device. For example, a sensor device 535 with a distance 575 of 2 millimeters may accommodate a greater distance 550 between the differentially coupled magnetic field sensing elements than a sensor device 535 with a distance 575 of 1.5 millimeters.

Because the strength of the magnetic field generated by a target drops exponentially with distance from the target, the strength of the magnetic field sensed by a magnetic field sensing element will be proportional to the magnetic field sensing element's distance from the target. And because a magnetic field sensing element in a second cluster may be some distance (e.g., distance 550) from its differentially coupled magnetic field sensing element in a first cluster, it may experience a much smaller magnetic field strength than the magnetic field sensing element in the first cluster, and as a result, the outputs from the two differentially coupled magnetic field signals will not cancel out when a difference between them is taken. However, because the magnetic field strength in the environment (and not attributable to the target) is typically relatively constant, taking the differential between the outputs of these magnetic field sensing elements will cause any contributions of the magnetic stray fields in the environment to cancel out, providing robustness of the sensor device against magnetic stray fields.

Providing a greater distance between the differentially coupled magnetic field sensing elements may provide a differential output signal for a channel (e.g., channel A, channel B) that is greater in amplitude, while still providing for robustness against the influence of magnetic stray fields. There may, however, be tradeoffs in how great a distance to provide between differentially coupled magnetic field sensing elements. For example, providing a greater distance between differentially coupled magnetic field sensing elements may require a greater die size for the sensor device, which may increase cost. Moreover, any gradual gradients that may exist in magnetic fields in an environment (and not attributable to the target) may not be compensated for if the differentially coupled magnetic field sensing elements are positioned at great distance from one another. Accordingly, these tradeoffs may be considered in designing a sensor device having a particular distance between differentially coupled magnetic field sensing elements.

Although there may be some reduction in signal amplitude when taking the differential between the outputs of the differentially coupled magnetic field sensing elements, because the magnetic field strength decreases exponentially, this reduction may be less than the loss experienced using other approaches to differentially sensing a magnetic field, such as the approaches described with respect to FIGS. 2A-3B.

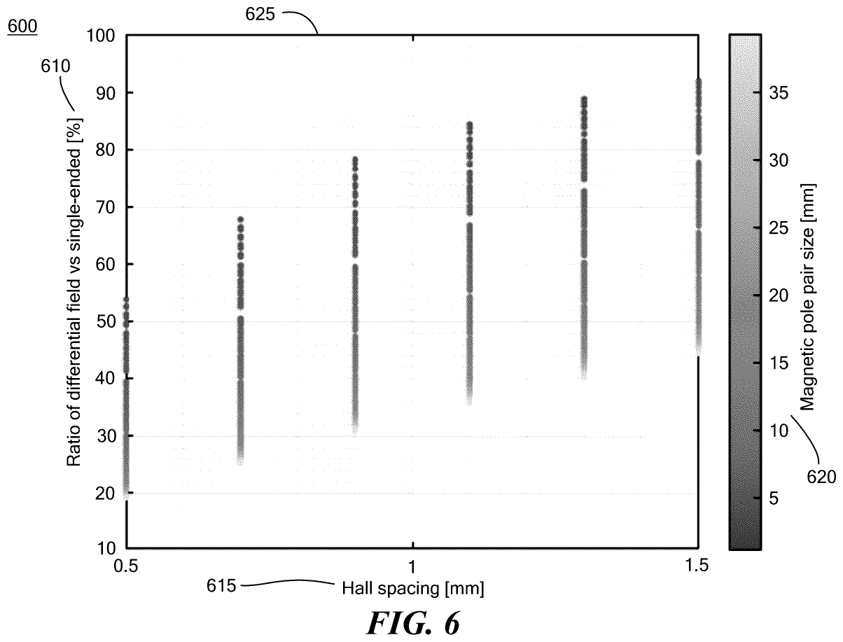

FIG. 6 shows a graph 600 of example simulated ratios of differentially measured magnetic field strengths to simulated single-ended measured magnetic field strengths. Graph 600 includes a Y-axis 610 that corresponds to a ratio of an amplitude of a differentially-sensed magnetic field strength to an amplitude of a single-ended sensed magnetic field strength in percent. Graph 600 also includes an X-axis 615 that corresponds to a spacing distance (e.g., distance 550) between differentially coupled magnetic field sensing elements (e.g., Hall elements). 620 is a legend showing the shading that corresponds to a particular pole pair size (in mm) of a target. 625 is a plot showing ratios of simulated differentially-sensed magnetic field strengths to simulated single-ended sensed magnetic field strengths of targets having a variety of different pole pair sizes, as sensed by a simulated example sensor device 535. Looking at sensor device 535 shown in FIG. 5, for example, a single-ended sensed magnetic field strength amplitude may correspond to an amplitude of an output signal from a magnetic field sensing element in cluster 540 only, whereas a differentially-sensed magnetic field strength amplitude may be the resulting amplitude after a difference is taken between the amplitude of the output signal from the magnetic field sensing element in cluster 540 and the amplitude of the output signal from its differentially coupled magnetic field sensing element in cluster 545.

Plot 625 shows that, as the distance (e.g., distance 550) between the differentially coupled magnetic field sensing elements increases, the ratio between the amplitude of the differential output signal from the output signals of the two differentially coupled magnetic field sensing elements (e.g., output signal from difference between output signal of element 555 and element 565) to a single-ended output signal (e.g., output signal from just element 555) also increases. That is, with greater distance between the differentially coupled magnetic field sensing elements, greater amplitude of the differential output signal is obtained, while maintaining robustness to magnetic stray fields from the environment. Plot 625 also shows that the ratio for a given distance (e.g., distance 550) may also vary depending on the magnetic pole pair size (in mm) of the target. Nevertheless, the ratios shown in FIG. 6 may still provide sufficient amplitudes for differential sensing in applications where rotation angle, speed, and/or direction of a target need to be detected. Thus, as shown in FIG. 6, use of a sensor device, such as example sensor device 535 as described above with respect to FIG. 5, may provide a sufficient differential output signal amplitude for use in applications using targets having a variety of different pole pair sizes.

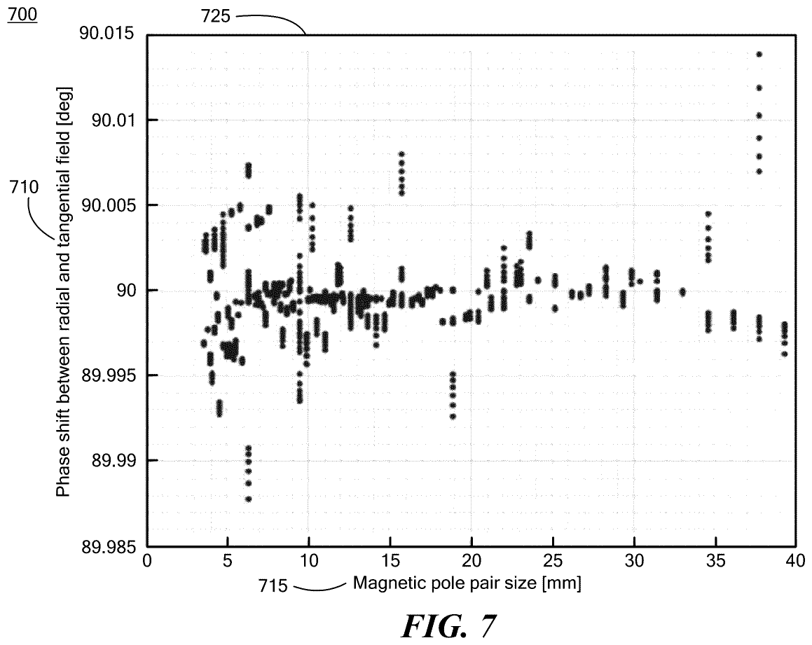

FIG. 7 shows a graph 700 of an example simulation of phase shifts determined between a differentially measured magnetic field strength in a radial direction and a differentially measured magnetic field strength in a tangential direction. Graph 700 includes a Y-axis 710 that corresponds to a phase shift between the magnetic field signal sensed (e.g., differentially sensed by magnetic field sensing elements 555 and 565 of FIG. 5) in the radial direction (e.g., radial direction 530 of FIG. 5) and the magnetic field strength sensed (e.g., differentially sensed by magnetic field sensing elements 560 and 570 of FIG. 5) in the tangential direction (e.g., tangential direction 525 of FIG. 5). Graph 700 also includes an X-axis 715 that corresponds to a magnetic pole pair size of the target (in mm). 725 is a plot showing the simulated phase shift for targets having different pole pair sizes when the distance (e.g., distance 550) between the differentially coupled magnetic field sensing elements is 1.5 mm. As can be seen from plot 725, use of a sensor device 535 as described above with respect to FIG. 5 provides a nearly perfect 90 degree phase shift between the magnetic field strength sensed in the radial direction and the magnetic field strength sensed in the tangential direction for targets having a variety of different pole pair sizes.

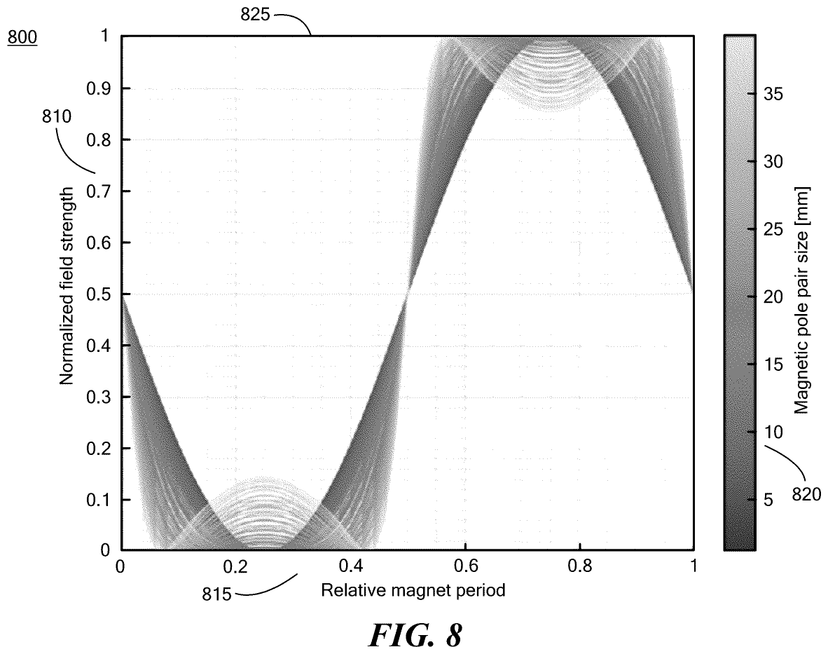

FIG. 8 shows a graph 800 of an example simulation of differentially measured magnetic field strengths in a radial direction. Graph 800 includes a Y-axis 810 that corresponds to magnetic field strength, normalized on a scale from 0 to 1. Graph 800 also includes an X-axis 815 that corresponds to a relative amount of the magnetic period as a target is rotated such that a pole pair passes in front of an example sensor device (e.g., sensor device 535). 820 is a legend showing the shading that corresponds to a particular pole pair size (in mm). 825 is a plot showing simulated magnetic field strengths that would be differentially measured (with magnetic field sensing elements spaced apart by 1.5 mm) by example sensor device 535 in a radial direction (e.g., radial direction 530) as targets with a variety of different pole pair sizes rotate such that a pole pair passes in front of the sensor device. As shown in plot 825, the simulated differentially measured magnetic field strength from example sensor device 535 in the radial direction would yield a similar sine/cosine curve as the target rotates across a pole pair regardless of pole pair size.

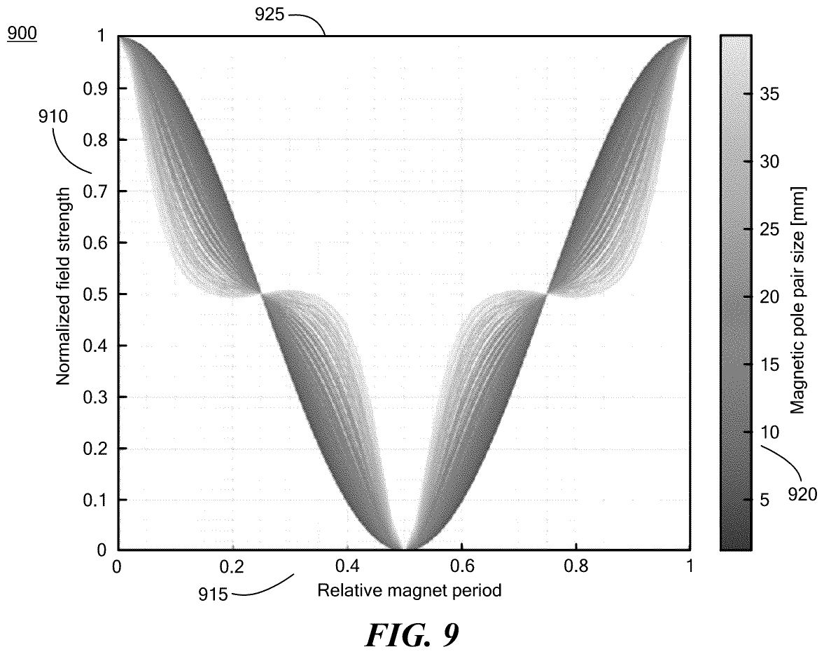

FIG. 9 shows a graph 900 of an example simulation of differentially measured magnetic field strengths in a tangential direction. Graph 900 includes a Y-axis 910 that corresponds to magnetic field strength, normalized on a scale from 0 to 1. Graph 900 also includes an X-axis 915 that corresponds to a relative amount of the magnetic period as a target is rotated such that a pole pair passes in front of an example sensor device (e.g., sensor device 535). 920 is a legend showing the shading that corresponds to a particular pole pair size (in mm). 925 is a plot showing simulated magnetic field strengths that would be differentially measured (with magnetic field sensing elements spaced apart by 1.5 mm) by example sensor device 535 in a tangential direction (e.g., tangential direction 525) as targets with a variety of different pole pair sizes rotate such that a pole pair passes in front of the sensor device. As shown in plot 925, the simulated differentially measured magnetic field strength from example sensor device 535 in the tangential direction would yield a similar sine/cosine curve as the target rotates across a pole pair, regardless of pole pair size.

As shown in FIGS. 8 and 9, the differentially-sensed magnetic field strength in the radial and tangential directions by example sensor device 535 have a steep signal slope around 25%, 30%, 35%, 40%, 60%, 65%, 70%, and 75% of the peak-to-peak measured magnetic field strength, which are example thresholds that may be set for rotation speed measurement applications, as discussed above with respect to FIGS. 3A and 3B. As can also be seen by comparing FIGS. 8 and 9, or by looking at FIG. 7, the differentially-sensed magnetic field strength in the radial and tangential directions are phase-shifted by an almost perfect 90 degrees, allowing for lead or lag detection based on the relative phase shift and/or timing between the two channel signals (e.g., channel A differentially measuring magnetic field strength in the radial direction and channel B differentially measuring magnetic field strength in the tangential direction), as discussed above with respect to FIGS. 3A and 3B. As a result, a sensor device, such as example sensor device 535, may allow for reliable switching and phase detection for use in rotation speed and/or rotation direction applications for a huge variety of targets, such as ring magnets having a huge variety of numbers of pole pairs and outer diameters.

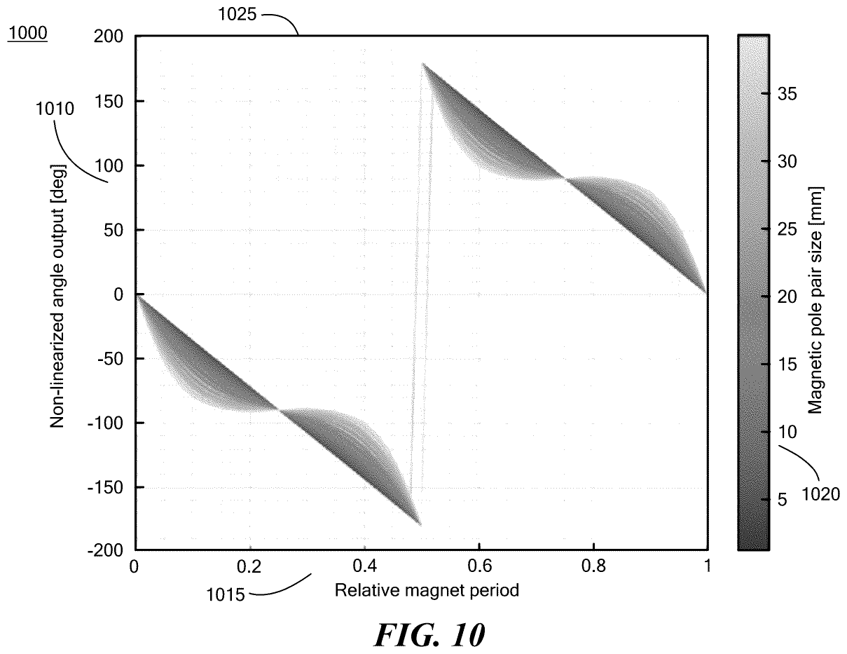

FIG. 10 shows a graph 1000 of an example simulation of values resulting from arctangent calculations of differentially measured magnetic field strengths in radial and tangential directions. Graph 1000 includes a Y-axis 1010 that corresponds to a non-linearized rotation angle measurement that results from the arctangent calculations. Graph 1000 also includes an X-axis 1015 that corresponds to a relative amount of the magnetic period as a target is rotated such that a pole pair passes in front of an example sensor device (e.g., sensor device 535). 1020 is a legend showing the shading that corresponds to a particular pole pair size (in mm). 1025 is a plot showing simulated values resulting from arctangent calculations of magnetic field strengths that would be differentially measured (with magnetic field sensing elements spaced apart by 1.5 mm) by example sensor device 535 in radial (e.g., radial direction 530) and tangential (e.g., tangential direction 535) directions as targets with a variety of different pole pair sizes rotate such that a pole pair passes in front of the sensor device. As shown in FIG. 10, 360 angular degrees of rotation (−180 degrees-180 degrees) are measured for each magnetic period as a target rotates such that a pole pair passes in front of the sensor device regardless of pole pair size. As previously discussed above with respect to FIGS. 1A-2B, having 90 degree phase-shifted sine/cosine curves may allow for determination of a rotation angle of a target, such as by calculating an arctangent of the two 90 degree phase-shifted curves. As a result, FIG. 10 shows that a sensor device, such as example sensor device 535, may also allow for reliable rotation angle detection of a target for a huge variety of targets, such as ring magnets having a huge variety of numbers of pole pairs and outer diameters.

Thus, a sensor device configured as discussed above with respect to FIG. 5, such as example sensor device 535, may allow for reliable detection of rotation speed, direction, and or angle for a huge variety of targets having different numbers of pole pairs, pole pair sizes, and/or outer diameters. This allows for use of a sensor device as discussed above with respect to FIG. 5 in a huge variety of applications. Using such a sensor device may be advantageous over other approaches, which may require production of many sensor devices having different spacings between differentially-coupled magnetic field sensing elements in order to match a pole pair size of a particular magnet.

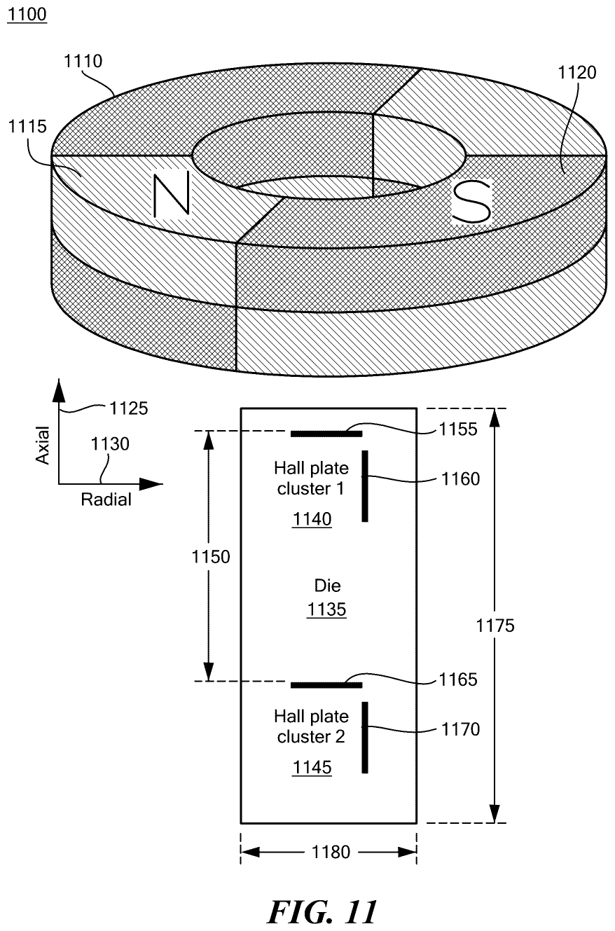

As discussed above, FIG. 5 shows a diagram of an example system 500 where a sensor device 535 was placed in an off-axis arrangement to a radially magnetized target 510. FIG. 11 shows a diagram of an example system 1100 where a sensor device 1135 is placed in an on-axis arrangement to an axially magnetized target 1110. Axially magnetized target 1110 may have one or more north poles 1115 and one or more south poles 1120. Example sensor device 1135 may be configured in the same manner as sensor device 535; however, in system 1100 where the target is axially magnetized, sensor device 1135 may be placed along an axis of rotation of the target either above or below the target. For example, sensor device 1135 may be positioned such that the axis of rotation of the target passes through sensor device 1135. Sensor device 1135 may be positioned next to target 1110 and may sense a magnetic field generated by target 1110 as target 1110 rotates. For example, sensor device 1135 may include two clusters of magnetic field sensing elements for sensing the magnetic field generated by the target. FIG. 11 shows example sensor device 1135 as including a first cluster 1140 (e.g., Hall plate cluster 1) that comprises two vertical Hall plates 1155, 1160 positioned orthogonal (i.e., perpendicular) to each other. FIG. 11 also shows example sensor device 1135 as including a second cluster 1145 (e.g., Hall plate cluster 2) that comprises two vertical Hall plates 1165, 1170 positioned orthogonal to each other. However, the disclosure is not so limited. For example, one of ordinary skill in the art would recognize that other types of magnetic field sensing elements may be used instead of vertical Hall plates, and that combinations of two or more different types of magnetic field sensing elements may be used together to sense the magnetic field generated by target 1110.

In some embodiments, sensor device 1135 is configured the same as sensor device 535, but when used with a target that is axially magnetized (e.g., target 1110), sensor device 535 would be rotated 90 degrees around an axis parallel to the tangential axis (e.g., tangential axis 525) and positioned along the axis (e.g., an axis in the axial direction 1125) around which the axially magnetized target (e.g., target 1110) rotates. In some embodiments, a magnetic field sensing element (e.g., vertical Hall plate 1155, vertical Hall plate 1165) from each cluster may have an axis of maximum sensitivity to the magnetic field generated by the target in the axial direction 1125, and another magnetic field sensing element (e.g., vertical Hall plate 1160, vertical Hall plate 1170) from each cluster may have an axis of maximum sensitivity to the magnetic field generated by the target in a radial direction 1130.

As with sensor device 535, the magnetic field sensing elements of sensor device 1135 may be differentially coupled. For example, the magnetic field sensing elements that have an axis of maximum sensitivity in an axial direction 1125 (e.g., vertical Hall plate 1155, vertical Hall plate 1165) may be differentially coupled together, and the magnetic field sensing elements that have an axis of maximum sensitivity in a radial direction 1130 (e.g., vertical Hall plate 1160, vertical Hall plate 1170) may be differentially coupled together. In some embodiments, a difference between a signal output from a magnetic field sensing element (e.g., vertical Hall plate 1155) in a first cluster 1140 (e.g., Hall plate cluster 1) and a signal output from its differentially coupled magnetic field sensing element (e.g., vertical Hall plate 1165) in a second cluster 1145 (e.g., Hall plate cluster 2) may be determined and output as one channel signal (e.g., Channel A). A difference between a signal output from a magnetic field sensing element (e.g., vertical Hall plate 1160) in first cluster 1140 (e.g., Hall plate cluster 1) and a signal output from its differentially coupled magnetic field sensing element (e.g., vertical Hall plate 1170) in a second cluster 1145 (e.g., Hall plate cluster 2) may also be determined and output as another channel signal (e.g., Channel B). The differences between the signals output from the magnetic field sensing elements may be determined, for example, as shown in Equations 1 and 2 above.

In some embodiments, differences between the outputs of the differentially coupled magnetic field sensing elements may be determined continuously. For example, outputs of the two differentially coupled magnetic field sensing elements may be continuously coupled into a differential amplifier, and a difference between the two outputs continuously output from the differential amplifier. Alternatively, outputs of the magnetic field sensing elements may be sampled at periodic intervals and differences between the outputs determined at those intervals.

As shown in FIG. 11, clusters of magnetic field sensing elements may be positioned in sensor device 1135 such that one cluster (e.g., cluster 1140) of magnetic field sensing elements is closer to the target (e.g., target 1110) than the other cluster (e.g., cluster 1145) of magnetic field sensing elements. In some embodiments, sensor device 1135 may comprise differentially coupled magnetic field sensing elements that are positioned a distance from each other. For example, a sensor device may be configured such that a magnetic field sensing element (e.g., vertical Hall plate 1155) in one cluster 1140 (e.g., Hall plate cluster 1) may be positioned a distance 1150 from its differentially coupled magnetic field sensing element (e.g., vertical Hall plate 1165) in another cluster 1145 (e.g., Hall plate cluster 2). Sensor device 1135 may also be configured such that another magnetic field sensing element (e.g., vertical Hall plate 1160) in cluster 1140 may also be positioned a distance from its differentially coupled magnetic field sensing element (e.g., vertical Hall plate 1170), and in some embodiments this distance may be the same distance as distance 1150, though the disclosure is not so limited.

In some embodiments, sensor device 1135 may be configured such that a cluster of magnetic field sensing elements is positioned near each end of the sensor device. For example, as shown in the example in FIG. 11, sensor device 1135 includes a cluster 1140 positioned near (i.e., proximal to) a first side of the sensor device that is near target 1110, and also includes a cluster 1145 positioned near (i.e., proximal to) a second side of the sensor device that is further away from target 1110. In some embodiments, a sensor device may have a substantially rectangular profile when viewed from above with four sides, two of the sides being shorter (e.g., a distance 1180) and two of the sides being longer (e.g., a distance 1175) in length, as shown in FIG. 11. In operation, the sensor device (e.g., sensor device 1135) may be positioned such that one of the shorter sides faces toward the target (e.g., target 1110) and one of the shorter sides faces away from the target.

One of skill in the art would recognize that a strength of a magnetic field generated by a target may drop exponentially with distance from the target. As a result, in the example shown in FIG. 11, magnetic field sensing element 1155 in cluster 1140 may detect a greater magnetic field strength than its differentially coupled magnetic field sensing element 1165 in cluster 1145. Likewise, magnetic field sensing element 1160 in cluster 1140 may detect a greater magnetic field strength than its differentially coupled magnetic field sensing element 1170 in cluster 1145. The distance between the differentially coupled magnetic field sensing elements may depend on the die size of the sensor device. For example, a sensor device 1135 with a distance 1175 of 2 millimeters may accommodate a greater distance 1150 between the differentially coupled magnetic field sensing elements than a sensor device 1135 with a distance 1175 of 1.5 millimeters.

Because the strength of the magnetic field generated by a target drops exponentially with distance from the target, the strength of the magnetic field sensed by a magnetic field sensing element will be proportional to the magnetic field sensing element's distance from the target. And because a magnetic field sensing element in a second cluster may be some distance (e.g., distance 1150) from its differentially coupled magnetic field sensing element in a first cluster, it may experience a much smaller magnetic field strength than the magnetic field sensing element in the first cluster, and as a result, the outputs from the two differentially coupled magnetic field signals will not cancel out when a difference between them is taken. However, because the magnetic field strength in the environment (and not attributable to the target) is typically relatively constant, taking the differential between the outputs of these magnetic field sensing elements will cause any contributions of the magnetic stray fields in the environment to cancel out, providing robustness of the sensor device against magnetic stray fields.

Providing a greater distance between the differentially coupled magnetic field sensing elements may provide a differential output signal in a channel (e.g., channel A, channel B) that is greater in amplitude, while still providing for robustness against the influence of stray magnetic fields. There may, however, be tradeoffs in how great a distance to provide between differentially coupled magnetic field sensing elements. For example, providing a greater distance between differentially coupled magnetic field sensing elements may require a greater die size for the sensor device, which may increase cost. Moreover, any gradual gradients that may exist in magnetic fields in an environment (and not attributable to the target) may not be compensated for if the differentially coupled magnetic field sensing elements are positioned at great distance from one another. Accordingly, these tradeoffs may be considered in designing a sensor device having a particular distance between differentially coupled magnetic field sensing elements.

FIG. 12 shows a block diagram of a system 1200 that includes an example sensor device 1235 and an example rotating target 1201, consistent with embodiments of the present disclosure. For example, sensor device 1235 may be a magnetic field sensor device configured to sense the magnetic field of target 1201, such as the magnetic field strength of target 1201, and to determine a rotation angle, speed, and/or direction of target 1201 based on the sensed magnetic field. Target 1201 may correspond, for example, to target 115 of FIG. 1A, target 165 of FIG. 1B, target 208 of FIG. 2B, target 345 of FIGS. 3A and 3B, target 510 of FIG. 5, and/or target 1110 of FIG. 11. As previously discussed, a rotating target may be a magnet attached to a rotating object that may rotate with the rotating object or may be a rotating object that is itself magnetized. Sensor device 1235 may correspond, for example, to sensor device 535 of FIG. 5 or sensor device 1135 of FIG. 11, though the disclosure is not so limited. A person of ordinary skill in the art would recognize that sensor device 1235 may be used in the same or a similar manner to that described herein in system arrangements other than those shown in FIG. 5 or FIG. 11, and those other system arrangements should be considered to be within the scope of the disclosure herein.

As previously discussed, a sensor device (e.g., sensor device 1235) may include one or more magnetic field sensing elements. For example, FIG. 12 illustrates sensor device 1235 as comprising four magnetic field sensing elements, magnetic field sensing element 1255, magnetic field sensing element 1260, magnetic field sensing element 1265, and magnetic field sensing element 1270. As discussed above, the magnetic field sensing elements may be organized into two clusters. For example, magnetic field sensing element 1255 and magnetic field sensing element 1260 may comprise a first cluster, and magnetic field sensing element 1265 and magnetic field sensing element 1270 may comprise a second cluster.

As previously discussed, the magnetic field sensing elements in each cluster may be positioned orthogonal to each other, so as to have an axis of maximum sensitivity aligned with orthogonal components of a magnetic field. For example, in the first cluster, magnetic field sensing element 1255 may be positioned orthogonal to magnetic field sensing element 1260. In the second cluster, magnetic field sensing element 1265 may be positioned orthogonal to magnetic field sensing element 1270.

As previously discussed, magnetic field sensing elements from each cluster that are configured to have an axis of maximum sensitivity aligned with the same component of the magnetic field may be differentially coupled. For example, magnetic field sensing element 1255 may be differentially coupled with magnetic field sensing element 1265, and magnetic field sensing element 1260 may be differentially coupled with magnetic field sensing element 1270. This differential coupling may provide two output channels, each comprising a signal that is a difference between the output signals of each of the differentially coupled magnetic field sensing elements. For example, magnetic field sensing element 1255 may be differentially coupled with magnetic field sensing element 1265 to provide an output channel A signal, and magnetic field sensing element 1260 may be differentially coupled with magnetic field sensing element 1270 to provide an output channel B signal. Such differential coupling may provide immunity of the output signal against magnetic stray fields in the environment that are not directly attributable to target 1201.

A previously discussed, a magnetic field sensing element may be any type of element sensitive to a magnetic field. For example, a magnetic field sensing element may be a Hall-effect element (e.g., a Hall plate), a magnetoresistance element, or a magnetotransistor element. For example, a magnetic field sensing element may be a Hall-effect element such as a planar Hall element (e.g., plate), a vertical Hall element (e.g., plate), or a circular vertical Hall (CVH) element (e.g., plate). A magnetic field sensing element may instead by a magnetoresistance element, such as an Indium Antimonide (InSb) element, a giant magnetoresistance (GMR) element (e.g., a spin valve element), an anisotropic magnetoresistance (AMR) element, a tunneling magnetoresistance (TMR) element, or a magnetic tunnel junction (MTJ) element. A magnetic field sensing element may be a receiving coil field sensing element. A magnetic field sensing element may be a single element, or alternatively may include two or more magnetic field sensing elements arranged in one of various configurations, such as a half bridge or full (Wheatstone) bridge. Depending on the type of sensor device and application requirements, a magnetic field sensing element may be a device made of a type IV semiconductor material such as Silicon (Si) or Germanium (Ge), or of a type III-V semiconductor material such as Gallium-Arsenide (GaAs) or an Indium compound such as Indium-Antimonide (InSb).

In some embodiments, multiple magnetic field sensing elements in a sensor device may be of the same type of magnetic field sensing element. For example, sensor device 1235 may include four magnetic field sensing elements 1255, 1260, 1265, 1270 which may be of the same type (e.g., vertical Hall plates). In some embodiments, there may be different types of magnetic field sensing elements that work together in a sensor device. For example, sensor device 1235 may include four magnetic field sensing elements 1255, 1260, 1265, 1270 which may be of different types.

In some embodiments, magnetic field sensing elements 1255, 1260, 1265, 1270 may output a signal, such as a voltage or current signal, in response to a nearby magnetic field. For example, a magnetic field generated by rotating target 1201 may cause a voltage to be output from magnetic field sensing elements 1255, 1260, 1265, 1270. The output voltage may be representative of a strength of the magnetic field that caused the voltage to be output from the magnetic field sensing element.

Positioning magnetic field sensing element 1255 to be orthogonal to magnetic field sensing element 1260, and magnetic field sensing element 1265 to be orthogonal to magnetic field sensing element 1270, may result in differential output signals (e.g., channel A, channel B) that are phase-shifted from one another by approximately 90 degrees. As previously discussed, providing these two phase-shifted signals may allow sensor device 1235 to determine a rotation angle of target 1201. For example, an angle of rotation of target 1201 at any given time may be determined based on the voltages output in the two differential signal channels at that time (e.g., using an inverse tangent function (arctan), two-argument arctangent function a tan 2, lookup table, polynomial fit, CORDIC calculation). As also previously discussed, the two phase-shifted signals may allow sensor device 1235 to determine a direction of rotation of a target. For example, the two phase-shifted signals may be compared to determine which of the two signals is leading or lagging the other, based on a relative phase shift or timing between the two signals, and this determination may be used to determine the direction of rotation of the target. As further previously discussed, the differential signal channels may also allow a rotation speed of the target to be determined. For example, threshold voltage values may be set and determinations made each time a voltage of a differential channel signal crosses a threshold voltage value. The frequency at which these crossings occur in a given time may then be used to determine a rotational speed of the target.

One of ordinary skill in the art would recognize that any calculations, algorithms, and/or comparisons that may be performed in making any of the above-described determinations (e.g., rotation angle, direction, and/or speed) may be made in logic in a digital controller, in analog circuitry, in digital circuitry, or in a combination of logic, analog circuitry, and/or digital circuitry. One of ordinary skill in the art would also recognize that one or more signals may be output from sensor device 1235, and any further calculations, algorithms, and/or comparisons that may be performed in making any of the above-described determinations may be determined by another controller or computing device that receives the one or more signals from sensor device 1235.

The signals (e.g., voltage signals) output by the magnetic field sensing elements (e.g., magnetic field sensing elements 1255, 1260, 1265, 1270) may be processed and/or conditioned along signal paths before being sent to a controller (e.g., digital controller 320). A signal path for processing/conditioning an output signal may include, for example, an amplifier and an analog-to-digital converter. For example, FIG. 12 illustrates output signals from magnetic field sensing element 1255 and magnetic field sensing element 1265 being differentially coupled through a differential amplifier 1225A. Differential amplifier 1225A may then output a differential signal 1226A to an analog-to-digital converter (ADC) 1230A, and ADC 1230A may then output a digital version of that differential signal to digital controller 1220. Similarly, FIG. 12 illustrates output signals from magnetic field sensing element 1260 and magnetic field sensing element 1270 being differentially coupled through a differential amplifier 1225B. Differential amplifier 1225B may then output a differential signal 1226B to an ADC 1230B, and ADC 1230B may then output a digital version of that differential signal to digital controller 12220.

As discussed above, a sensor device may also include one or more controllers. The controller(s) may include digital and/or analog circuitry. For example, sensor device 1235 of FIG. 12 includes a digital controller 1220. The controller may include any suitable type of processing circuitry, such as an application-specific integrated circuit (ASIC), a field programmable gate array (FPGA), a CORDIC processor, a special-purpose processor, synchronous digital logic, asynchronous digital logic, a general-purpose computer (e.g., MIPS processor, x86 processor), etc. The one or more controllers may also include a clock. The clock may timestamp when voltages of differential signals received by digital controller 1220 are recorded (e.g., timestamp with an elapsed amount of time measured by the clock), such that, for example, determined rotation angle measurements, rotation directions, crossings of voltage thresholds, and/or rotation speeds and the times at which the differential signals used to make these determinations were received may be stored in a memory (e.g., memory 1224). One of skill in the art would recognize that the clock need not be internal to the one or more controllers, and may instead be an external component connected to the one or more controllers.

The sensor device may also include one or more memories. For example, sensor device 1235 of FIG. 12 includes a memory 1224. The memory may include any suitable type of volatile and/or non-volatile memory. In some embodiments, the memory may be a non-transitory computer-readable medium. By way of example, memory 1224 may include a random-access memory (RAM), a dynamic random-access memory (DRAM), an electrically-erasable programmable read-only memory (EEPROM), and/or any other suitable type of memory. The memory may store instructions that, when executed by the controller(s), cause the controller(s) to carry out certain determinations, steps, processes, comparisons, algorithms, and/or calculations, consistent with the embodiments of the present disclosure. For example, FIG. 12 illustrates memory 1224 as storing instructions that, when executed by the controller, may cause the controller(s) to (1) determine a rotation speed of a target (e.g., speed identification (ID) instructions 1214), (2) determine a rotation direction of a target (e.g., direction ID instructions 1216), and/or (3) determine a rotation angle of a target (e.g., angle ID instructions 1217). These instructions may cause the controller(s) to determine one or more of rotation speed, rotation direction, and/or rotation angle of a target, as discussed herein.

The sensor device may include one or more voltage regulators. For example, sensor device 1235 of FIG. 12 includes voltage regulator(s) 1226. Voltage regulator(s) may, for example, receive voltage (e.g., from VCC pin 1232) and convert or regulate the voltage to provide a stable power supply to the controller(s) (e.g., digital controller 1220), magnetic field sensing element(s) (e.g., magnetic field sensing elements 1255, 1260, 1265, 1270), amplifier(s) (e.g., amplifier(s) 1225A, 1225B), ADC(s) (e.g., ADCs 1230A, 1230B), one or more memories (e.g., memory 1224), output interface(s) (e.g., output interface 1230), and/or any other circuitry in sensor device 1235. Although not shown, one of skill in the art would recognize that the sensor device and components of the sensor device may also be connected to a ground (GND) voltage level via one or more pins.

The sensor device may also include one or more output interfaces. For example, sensor device 1235 includes an output interface 1230. An output interface may include any suitable type of interface for outputting a signal (e.g., output signal 1234). The output interface(s) may include one or more of a wired or wireless interface. By way of example, the output interface(s) may include a current modulator for sensing information along a conductor via current pulses, a voltage modulator for sending information along a conductor via voltage pulses, an Inter-Integrated Circuit (I2C) interface, a Controller Area Network (CAN) bus interface, a WiFi interface, an Ethernet interface, a Universal Serial Bus (USB) interface, a local area network (LAN) interface, a cellular (e.g., 5G) interface, and/or any other suitable type of interface.

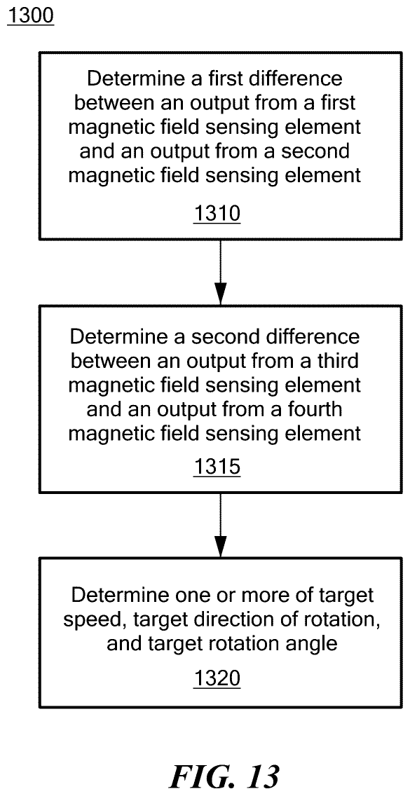

FIG. 13 shows a flow diagram of an example process 1300 for differentially sensing a magnetic field of a target, consistent with embodiments of the present disclosure. Example process 1300 may be implemented by circuitry and/or one or more controllers (e.g., digital controller 1220) of a sensor device (e.g., sensor device 535, sensor device 1135, sensor device 1235). For example, using example process 1300, controller(s) may determine one or more of a rotation angle, speed, and/or direction of a target. As previously discussed, example process 1300 may be implemented by a sensor device (e.g., sensor device 535, sensor device 1135, sensor device 1235) to determine rotation angle, speed, and/or direction of a target for a wide range of targets having a variety of different characteristics, such as wide variations in numbers of pole pairs, pole pair size, and/or outer diameter of a target.

In 1310, a difference between an output (e.g., voltage output) from a first magnetic field sensing element and an output (e.g., voltage output) from a second magnetic field sensing element may be determined. For example, as discussed above with respect to FIGS. 5, 11, and 12, a difference between a signal representative of magnetic field strength sensed by a first magnetic field sensing element (e.g., vertical Hall plate 555, vertical Hall plate 1155, vertical Hall plate 1255) in a first cluster and a signal representative of magnetic field strength sensed by a differentially coupled second magnetic field sensing element (e.g., vertical Hall plate 565, vertical Hall plate 1165, vertical Hall plate 1265) in a second cluster may be determined. As previously discussed, this difference may be determined by, for example, inputting signals output from the first magnetic field sensing element and the second magnetic field sensing element into a differential amplifier (e.g., differential amplifier 1225A), and the differential amplifier may output the difference. Alternatively, this difference may be determined by other circuitry and/or by one or more controllers sampling the outputs and calculating the difference.

In 1315, a difference between an output (e.g., voltage output) from a third magnetic field sensing element and an output (e.g., voltage output) from a fourth magnetic field sensing element may be determined. For example, as discussed above with respect to FIGS. 5, 11, and 12, a difference between a signal representative of magnetic field strength sensed by a third magnetic field sensing element (e.g., vertical Hall plate 560, vertical Hall plate 1160, vertical Hall plate 1260) in the first cluster and a signal representative of magnetic field strength sensed by a differentially coupled fourth magnetic field sensing element (e.g., vertical Hall plate 570, vertical Hall plate 1170, vertical Hall plate 1270) in the second cluster may be determined. As previously discussed, this difference may be determined by, for example, inputting signals output from the third magnetic field sensing element and the fourth magnetic field sensing element into a differential amplifier (e.g., differential amplifier 1225B), and the differential amplifier may output the difference. Alternatively, this difference may be determined by other circuitry and/or by one or more controllers sampling the outputs and calculating the difference.

In 1320, one or more of a rotation angle, speed, or direction of a target may be determined. For example, as previously discussed, digital logic in one or more controllers (e.g., digital controller 1220), analog circuitry, and/or digital circuitry may perform comparisons, algorithms, determinations, and/or calculations to determine a rotation angle, speed, and/or direction of a target. For example, as previously discussed a digital controller 1220 may execute instructions (e.g., angle ID instructions 1217) that determine a rotation angle of the target. As previously discussed, these instructions may cause digital controller 1220 to determine a rotation angle of the target based on the differential signals received in two channels by, for example, using an inverse tangent function (arctan), two-argument arctangent function a tan 2, lookup table, polynomial fit, or CORDIC calculation. As previously discussed, a digital controller 1220 may execute instructions (e.g., direction ID instructions 1216) that determine a rotation direction of a target. As previously discussed, these instructions may cause digital controller 1220 to determine a rotation direction of the target based on the differential signals received in two channels by, for example, comparing the phase-shifted signals from the two channels to determine which of the signals is leading or lagging, and using that determination to determine direction of rotation of the target. As further previously discussed, a digital controller 1220 may execute instructions (e.g., speed ID instructions 1214) that determine a rotation speed of a target. As previously discussed, these instructions may cause digital controller 1220 to record times at which a signal of a channel crosses a threshold level, and to determine a speed of rotation of the target based on how many crossings occur in a given time period.

Furthermore, as previously discussed, 1320 may be performed in a controller or computing device outside a sensor device. For example, a sensor device may output one or more signals representative of the magnetic field sensed by the magnetic field sensing elements and a controller or computing device may receive the one or more signals and determine one or more of a rotation angle, rotation direction, and/or rotation speed of the target.

Although process 1300 in FIG. 13 shows 1315 as occurring after 1310, one of ordinary skill in the art would recognize that 1315 may occur before 1310, or simultaneously with 1310, and the disclosure herein should be considered to include these alternatives as well.

As used herein, the terms “processor” and “controller” are used to describe electronic circuitry that performs a function, an operation, or a sequence of operations. The function, operation, or sequence of operations can be hard coded into the electronic circuit or soft coded by way of instructions held in a memory device. The function, operation, or sequence of operations can be performed using digital values or using analog signals. In some embodiments, the processor or controller can be embodied in an application specific integrated circuit (ASIC), which can be an analog ASIC or a digital ASIC, in a microprocessor with associated program memory and/or in a discrete electronic circuit, which can be analog or digital. A processor or controller can contain internal processors or modules that perform portions of the function, operation, or sequence of operations. Similarly, a module can contain internal processors or internal modules that perform portions of the function, operation, or sequence of operations of the module.

While electronic circuits shown in figures herein may be shown in the form of analog blocks or digital blocks, it will be understood that the analog blocks can be replaced by digital blocks that perform the same or similar functions and the digital blocks can be replaced by analog blocks that perform the same or similar functions. Analog-to-digital or digital-to-analog conversions may not be explicitly shown in the figures but should be understood.

Various embodiments of the systems and methods are described herein with reference to the related drawings. Alternative embodiments can be devised without departing from the scope of the described concepts. It is noted that various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. As an example of an indirect positional relationship, references in the present description to element or structure A over element or structure B include situations in which one or more intermediate elements or structures (e.g., element C) is between elements A and B regardless of whether the characteristics and functionalities of elements A and/or B are substantially changed by the intermediate element(s).

Furthermore, it should be appreciated that relative, directional or reference terms (e.g. such as “above,” “below,” “left,” “right,” “top,” “bottom,” “vertical,” “horizontal,” “front,” “back,” “rearward,” “forward,” etc.) and derivatives thereof are used only to promote clarity in the description of the figures. Such terms are not intended as, and should not be construed as, limiting. Such terms may simply be used to facilitate discussion of the drawings and may be used, where applicable, to promote clarity of description when dealing with relative relationships, particularly with respect to the illustrated embodiments. Such terms are not, however, intended to imply absolute relationships, positions, and/or orientations. For example, with respect to an object or structure, an “upper” or “top” surface can become a “lower” or “bottom” surface simply by turning the object over. Nevertheless, it is still the same surface and the object remains the same. Also, as used herein, “and/or” means “and” or “or,” as well as “and” and “or.” Moreover, all patent and non-patent literature cited herein is hereby incorporated by references in their entirety.

The terms “disposed over,” “overlying,” “atop,” “on top,” “positioned on” or “positioned atop” mean that a first element, such as a first structure, is present on a second element, such as a second structure, where intervening elements or structures (such as an interface structure) may or may not be present between the first element and the second element. The term “direct contact” means that a first element, such as a first structure, and a second element, such as a second structure, are connected without any intermediary elements or structures between the interface of the two elements. The term “connection” can include an indirect connection and a direct connection.

It should be recognized that values described herein may be exact or approximate. One of ordinary skill in the art would recognize that values described herein may vary depending on, for example, manufacturing tolerances of components in sensor devices. As a result, values that deviate from a described value by up to +/−20% of the described value may be deemed to correspond to the value described.

In the foregoing detailed description, various features are grouped together in one or more individual embodiments for the purpose of streamlining the disclosure. This method of disclosure is not to be interpreted as reflecting an intention that each claim requires more features than are expressly recited therein. Rather, inventive aspects may lie in less than all features of each disclosed embodiment.

References in the disclosure to “one embodiment,” “an embodiment,” “some embodiments,” or variants of such phrases indicate that the embodiment(s) described can include a particular feature, structure, or characteristic, but every embodiment can include the particular feature, structure, or characteristic. Moreover, such phrases are not necessarily referring to the same embodiment(s). Further, when a particular feature, structure, or characteristic is described with reference to one embodiment, knowledge of one skilled in the art may be relied upon to affect such feature, structure, or characteristic in connection with other embodiments whether or not explicitly described.

The disclosed subject matter is not limited in its application to the details of construction and to the arrangements of the components set forth in the following description or illustrated in the drawings. The disclosed subject matter is capable of other embodiments and of being practiced and carried out in various ways. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

All publications and references cited herein are expressly incorporated herein by reference in their entirety.

1. A magnetic field sensor (900) for sensing motion of a ferromagnetic object (930a, b, c), comprising:
a substrate (902), comprising:
a first major surface (902a), wherein a first dimension across the first major surface of the substrate defines a width dimension of the substrate and a second dimension across the first major surface of the substrate perpendicular to the width dimension defines a length dimension of the substrate;
first and second substrate edges (902c, 902d) at ends of the width of the substrate; and
a second major surface (902b) parallel to the first major surface,
wherein the magnetic field sensor further comprises:
a magnet (922), comprising:
a first major surface (922a) proximate to the substrate and parallel to the first major surface of the substrate, wherein a first dimension across the first major surface of the magnet defines a width dimension of the magnet and a second dimension across the first major surface of the magnet perpendicular to the width dimension defines a length dimension of the magnet;
a second major surface (922b) distal from the substrate and parallel to the first major surface of the magnet; and
a magnet axis (926) perpendicular to the first and second major surfaces of the magnet and centered within the width dimension and length dimension of the magnet, wherein the magnetic field sensor further comprises:
a first magnetic field sensing element (904) disposed upon the first major surface or the second major surface of the substrate and configured to generate a first magnetic field signal, wherein the first magnetic field sensing element comprises a center; and
a second magnetic field sensing (908) element disposed upon the first major surface or the second major surface of the substrate and configured to generate a second magnetic field signal, wherein the second magnetic field sensing element comprises a center, wherein the center of the first magnetic field sensing element and the center of the second magnetic field sensing element are the same distance from the first major surface of the magnet, wherein a line passing through the first and second magnetic field sensing elements intersects the ferromagnetic object, in use, wherein the line passing through the first and second magnetic field sensing elements is parallel to the width dimension of the substrate and parallel to the width dimension of the magnet, wherein the center of the first magnetic field sensing element and the center of the second magnetic field sensing element are positioned upon the substrate beyond the first and second respective ends of the width dimension of the magnet such that first and second lines passing through the first and second centers, respectively, of the first and second magnetic field sensing elements and perpendicular to the first major surface of the substrate, do not intersect the magnet, wherein, in use, the second magnetic field sensing element is farther from the ferromagnetic object than the first magnetic field sensing element, resulting in the first magnetic field sensing element being more responsive to the motion of the ferromagnetic object than the second magnetic field sensing element, wherein the magnet is offset from the line passing through the first and second magnetic field sensing elements in a direction perpendicular to the line passing through the first and second magnetic field sensing elements, and wherein the line passing through the first and second magnetic field sensing elements is perpendicular to the magnet axis.

2. The magnetic field sensor of claim 1, wherein the magnet is comprised of a hard ferromagnetic material, and wherein the magnet does not have a core comprised of a different material.

3. The magnetic field sensor of claim 1, wherein the magnet comprises magnetic particles molded within a mold compound.

4. The magnetic field sensor of claim 1, further comprising an electronic circuit disposed upon the substrate, coupled to receive the first and second magnetic field signals and configured to combine the first and second magnetic field signals.

5. The magnetic field sensor of claim 1, further comprising:
a leadframe over which the substrate is disposed, the leadframe comprising a plurality of leads;
a molded body encapsulating the substrate and selected parts of the leadframe; and
one or more passive electronic components disposed within the molded body and electrically coupled to at least two of the plurality of leads.

6. The magnetic field sensor of claim 1, wherein the first magnetic field sensing element is selected from among a first plurality of magnetic field sensing elements disposed upon the first surface of the substrate, wherein the first magnetic field sensing element is responsive, in use, to the motion of the ferromagnetic object and other ones of the first plurality of magnetic field sensing element are inactive, and the second magnetic field sensing element is selected from among a second plurality of magnetic field sensing elements disposed upon the first major surface or the second major surface of the substrate, wherein the second magnetic field sensing element is responsive, in use, to the motion of the ferromagnetic object and other ones of the second plurality of magnetic field sensing elements are inactive.

7. The magnetic field sensor of claim 1, wherein the substrate further comprises a substrate center axis perpendicular to the first and second major surface of the substrate and centered within the width dimension and length dimension of the substrate; wherein the magnet axis is substantially parallel to and proximate to the substrate center axis.

8. The magnetic field sensor of claim 1, wherein the first magnetic field sensing element is responsive to the motion of the ferromagnetic object, in use, and wherein the second magnetic field sensing element is positioned so as to be less responsive to the motion of the ferromagnetic object, in use.

9. The magnetic field sensor of claim 1, wherein the first magnetic field sensing element is selected from among a plurality of magnetic field sensing elements disposed upon the first major surface or the second major surface of the substrate, wherein the first magnetic field sensing element is responsive to the motion of the ferromagnetic object, in use, and other ones of the plurality of magnetic field sensing elements are inactive.

10. The magnetic field sensor of any of the above claims, wherein the magnetic field sensor is operable to generate an output signal indicative of a tooth detector and not an edge detector.

11. A magnetic field sensor (900) for sensing motion of a ferromagnetic object (930a-c), comprising:
a substrate (902), comprising:
a first major surface (902a), wherein a first dimension across the first major surface of the substrate defines a width dimension of the substrate and a second dimension across the first major surface of the substrate perpendicular to the width dimension defines a length dimension of the substrate;
first and second substrate edges (902c, 902d) at ends of the width dimension of the substrate; and
a second major surface (902b) parallel to the first major surface,
wherein the magnetic field sensor further comprises:
a magnet (922), comprising:
a first major surface (922a) proximate to the substrate and substantially parallel to the first major surface of the substrate, wherein a first dimension across the first major surface of the magnet defines a width dimension of the magnet and a second dimension across the first major surface of the magnet perpendicular to the width dimension defines a length dimension of the magnet;
a second major surface (922b) distal from the substrate and parallel to the first major surface of the magnet; and
a magnet axis (926) perpendicular to the first and second major surfaces of the magnet and centered within the width dimension and length dimension of the magnet, wherein the magnetic field sensor further comprises:
a first magnetic field sensing element (906) disposed upon the first major surface or the second major surface of the substrate and configured to generate a first magnetic field signal, wherein the first magnetic field sensing element comprises a center; and
a second magnetic field sensing element (908) disposed upon the first major surface or the second major surface of the substrate and configured to generate a second magnetic field signal, wherein the second magnetic field sensing element comprises a center, wherein the center of the first magnetic field sensing element and the center of the second magnetic field sensing element are the same distance from the first major surface of the magnet, wherein a line passing through the first and second magnetic field sensing elements intersects the ferromagnetic object, in use, wherein the line passing through the first and second magnetic field sensing elements is parallel to the width dimension of the substrate and parallel to the width dimension of the magnet, wherein, in use, the second magnetic field sensing element is substantially farther from the ferromagnetic object than the first magnetic field sensing element, resulting in the first magnetic field sensing element being substantially more responsive to the motion of the ferromagnetic object than the second magnetic field sensing element, wherein the magnet is offset from the line passing through the first and second magnetic field sensing elements in a direction perpendicular to the line passing through the first and second magnetic field sensing elements, and wherein the line passing through the first and second magnetic field sensing elements is perpendicular to the magnet axis, wherein the first magnetic field sensing element is selected from among a plurality of magnetic field sensing elements disposed upon the first major surface or the second major surface of the substrate, wherein the first magnetic field sensing element has a response to the motion of the ferromagnetic object, in use, and other ones of the plurality of magnetic field sensing elements are inactive.

12. A magnetic field sensor (900) for sensing motion of a ferromagnetic object (930a-c), comprising:
a substrate (902), comprising:
a first major surface (902a), wherein a first dimension across the first major surface of the substrate defines a width dimension of the substrate and a second dimension across the first major surface of the substrate perpendicular to the width dimension defines a length dimension of the substrate;
first and second substrate edges (902c, 902d) at ends of the width dimension of the substrate; and
a second major surface (902b) parallel to the first major surface,
wherein the magnetic field sensor further comprises:
a magnet (922), comprising:
a first major surface (922a) proximate to the substrate and substantially parallel to the first major surface of the substrate, wherein a first dimension across the first major surface of the magnet defines a width dimension of the magnet and a second dimension across the first major surface of the magnet perpendicular to the width dimension defines a length dimension of the magnet;
a second major surface (922b) distal from the substrate and parallel to the first major surface of the magnet; and
a magnet axis (926) perpendicular to the first and second major surfaces of the magnet and centered within the width dimension and length dimension of the magnet, wherein the magnetic field sensor further comprises:
a first magnetic field sensing element (904) disposed upon the first major surface or the second major surface of the substrate and configured to generate a first magnetic field signal, wherein the first magnetic field sensing element comprises a center; and
a second magnetic field sensing element (908) disposed upon the first major surface or the second major surface of the substrate and configured to generate a second magnetic field signal, wherein the second magnetic field sensing element comprises a center, wherein the center of the first magnetic field sensing element and the center of the second magnetic field sensing element are the same distance from the first major surface of the magnet, wherein a line passing through the first and second magnetic field sensing elements intersects the ferromagnetic object, in use, wherein the line passing through the first and second magnetic field sensing elements is parallel to the width dimension of the substrate and parallel to the width dimension of the magnet, wherein, in use, the second magnetic field sensing element is substantially farther from the ferromagnetic object than the first magnetic field sensing element, resulting in the first magnetic field sensing element being substantially more responsive to the motion of the ferromagnetic object than the second magnetic field sensing element, wherein the magnet is offset from the line passing through the first and second magnetic field sensing elements in a direction perpendicular to the line passing through the first and second magnetic field sensing elements, and wherein the line passing through the first and second magnetic field sensing elements is perpendicular to the magnet axis, wherein the magnetic field sensor is operable to generate an output signal indicative of a tooth detector and not an edge detector.
